(19) United States
(12) Patent Application Publication
(10) Pub. No.: US 2025/0086553 A1
(43) Pub. Date: Mar. 13, 2025

(54) Systems and Methods for Automating Operational Due Diligence Analysis to Objectively Quantify Risk Factors

(71) Applicant: AON GLOBAL OPERATIONS SE, SINGAPORE BRANCH, Singapore (SG)

(72) Inventors: Rian AKEY, Chicago, IL (US); Ryan HARRISON, Chicago, IL (US)

(73) Assignee: AON GLOBAL OPERATIONS SE, SINGAPORE BRANCH, Singapore (SG)

(21) Appl. No.: 18/670,423

(22) Filed: May 21, 2024

Related U.S. Application Data
(63) Continuation of application No. 17/030,814, filed on Sep. 24, 2020, now abandoned.
(60) Provisional application No. 62/905,605, filed on Sep. 25, 2019.
(60) Provisional application No. 62/923,686, filed on Oct. 21, 2019.

(51) Int. Cl. G06Q 10/0635; G06F 3/0482; G06Q 10/0637; G06Q 10/0639; G06Q 10/105; G06Q 30/018; G06Q 30/0203; G06Q 30/0204; G06Q 40/06; G06Q 40/08; G06Q 50/26

(52) U.S. Cl. CPC G06Q 10/0635; G06Q 10/0637; G06Q 10/06393; G06Q 10/105; G06Q 30/0185; G06Q 30/0203; G06Q 30/0205; G06Q 40/06; G06Q 40/08; G06Q 50/26; G06F 3/0482

(57) ABSTRACT

Systems and methods for objectively conducting an operational due diligence (ODD) assessment of an investment vehicle manager's operations include providing, to each of a population of managers, an electronically-fillable questionnaire including a number of questions regarding risk factors, each risk factor belonging to one of a number of practice aspects, each question requiring selection from a number of standardized answer options. The answers collected from the number of managers may be combined to identify a propensity for exhibiting each of the number of risk factors across portions of the manager population. Each manager may be benchmarked against the propensity of manager population(s) to provide an objective assessment of manager performance and, in combination, portfolio performance in relation to real world common practices. Results of analysis and benchmarking may be provided in an interactive report for review.

### RELATED APPLICATIONS

This application is a continuation of and claims priority to U.S. patent application Ser. No. 17/030,814, entitled “Systems and Methods for Automating Operational Due Diligence Analysis to Objectively Quantify Risk Factors,” filed Sep. 24, 2020, which claims priority to both U.S. Provisional Patent Application Ser. No. 62/905,605, entitled “Systems and Methods for Automating Operational Due Diligence Analysis to Objectively Quantify Risk Factors,” filed Sep. 25, 2019, and to U.S. Provisional Patent Application Ser. No. 62/923,686, entitled “Systems and Methods for Automating Operational Due Diligence Analysis to Objectively Quantify Risk Factors,” filed Oct. 21, 2019. All above identified applications are hereby incorporated by reference in their entireties.

### BACKGROUND

Operational due diligence relates to various aspects of assessing the running of a business to mitigate risk to clients as well as members of the organization in the area of operations. For investment entities, such as investment funds, private equity funds, infrastructure funds, and hedge funds, operational due diligence aspects can include an assessment of an investment vehicle manager's practices in the general areas of governance, technology and cyber security, vendor management, trade settlement, and back office functions.

Traditionally, investment vehicle managers have been presented with periodic (e.g., annual) due diligence questionnaires, such as a paper form or electronic document including a series of questions related to the different due diligence aspects of the manager's practice. Upon return of the questionnaire, which may take a matter of weeks, an initial review is conducted of the questionnaire to identify any areas requiring clarification or expansion into the provided responses. Once the questionnaire is deemed complete, a reviewer reads through the provided responses, often in sentence format, and identifies areas of risk, generating a summary of the reviewer's findings and an overall assessment, often including a rating. This individualized process is time consuming, expensive, and highly subjective. For example, for thousands of dollars and a matter of months' lead time, a client may receive information regarding an identified manager. However, most clients' portfolios involve many managers, compounding the expense and drawing the time lag out even further. To reduce budget, clients have opted to rotate through the various managers in their portfolio or to skip some managers rather than conducting full periodic reviews.

Conversely, managers may be requested to fill out a number of questionnaires provided by different clients, the vast majority of each questionnaire including duplicate or overlapping questions, because no standardized mechanism exists for conducting operational assessments of investment vehicle managers. Because the investment vehicle managers employ a number of individuals, different surveys may be filled in differently simply based upon who is filling out which questionnaire, since fill-in-the-blank questions leave much room for interpretation and breadth/specificity of answer. Thus, each client may obtain a somewhat different view of potential risk from a same manager.

The inventors recognized a need for a faster, less expensive, and more objective system for assessing investment vehicle managers' operations.

### SUMMARY OF ILLUSTRATIVE EMBODIMENTS

In one aspect of the present disclosure, systems and methods for conducting automated or semi-automated operational due diligence reviews of investment vehicle management organizations provide a data-driven approach to present objective comparisons between the investment vehicle management organizations. The objective comparisons may allow for more consistent decision making and optimized resource allocation. Further, the data-driven automated approach should increase efficiency, thereby decreasing cost and increasing speed of ODD reviews through improved data collection and automated reporting capabilities.

In some embodiments, survey questions presented to investment vehicle management organizations and corresponding answer options provided to the investment vehicle management organizations for responding to the survey questions are organized in a data format designed to streamline the collection and report writing aspects of the ODD review process. Since the answer data including the answer option selections is collected electronically, responses provided by the various investment vehicle management organizations can be analyzed and compared to develop market intelligence and benchmarking information across a range of operational risk factors.

In some embodiments, the objectivity of the analyzed results lies in part in presenting the information without weighting, ranking, or otherwise subjectively sorting the risk factors. For example, if a particular investment vehicle manager answers a question in a manner not conforming to what is considered a “best practice” in risk mitigation, the risk factor corresponding to the question may be highlighted. In a subjective analysis, it was difficult to derive the severity of risk associated with any particular risk factor in comparison to other risk factors, leading potentially to poor decision making based upon familiarity with a particular risk factor or past experience with the particular risk factor causing a subjective weighting in the mind of an evaluating organization and/or with the reviewer of an ODD report. When, instead, comparisons are made between fixed response answers of a large group of managers, industry trends are uncovered, identifying which best practices are adopted by a majority of investment vehicle managers and which best practices, while being best practices in an academic sense, have not gained traction industry-wide. As an illustrative example, when a particular investment vehicle manager responds that it does not require multi-factor authentication for remote access to its computing systems, that response can be compared across potentially hundreds of other managers to determine the commonality of that particular response. This results in a fact (e.g., percentage industry adoption) rather than a subjective opinion (e.g., investment vehicle managers ought to require multi-factor authentication). If there is a lack of industry adoption, there may be an underlying reason for this discrepancy (e.g., common investment vehicle manager software platforms are not designed to support multi-factor authentication). Conversely, if there is widespread adoption of a certain practice, the factual data enabled by the systems and methods described herein can be used as an impetus to direct the non-conforming managers to update their risk mitigation practices. Thus, the systems and methods described herein provide a technical solution to the lack of survey participant visibility into the feasibility and/or importance of applying certain risk mitigation corresponding to a risk discovered by a prior art operational risk due diligence survey.

The survey questions, in some embodiments, represent a risk inventory of a variety of types of risks. Certain portions of the risk inventory relate to how the investment vehicle manager applies best practices to firm management, such as technology practices, accounting practices, and human resources practices. Other portions of the risk inventory may be applicable to a particular investment vehicle manager depending upon the type(s) of investment strategies offered by the investment vehicle manager and/or the structure of the investment vehicle. As additional risk topics are added to the risk inventory, the automated methods and systems described herein are designed to scale and accommodate for topic expansion as well as, if applicable, audience expansion to addition types of investment vehicle managers. In illustration, although ODD began primarily as a hedge fund due diligence effort, over time ODD review has migrated into traditional strategies and, most recently, into private market strategies like real estate and venture/private equity. Thus, the systems and methods described herein, although largely illustrated in relation to public market strategies, are equally applicable to private market strategies. Thus, the survey structure and architecture provides a technical solution to the problem of easily updating risk surveys to comport with changes in best practices while providing continuity in trend analysis among participants.

The systems and methods described herein are additionally designed to provide more frequent analysis of investment vehicle managers. Through increases in efficiency afforded through the data-driven, automated answer collection process and automated analysis thereof, investment vehicle managers may be periodically monitored to confirm, after initial investment by a client with the investment vehicle manager, that the manager has kept pace with a changing technology environment. Further, prior responses from a particular manager may be maintained and reviewed to assess whether a particular investment vehicle manager has ceased to exhibit previously applied best practices. These reassessments may take place, in some examples, annually, semi-annually, or quarterly.

In one aspect, systems and methods described herein establish consistent and objective analysis appropriate to audit support in a manner not before available. The analysis results, for example, may be shared with regulators or internal audit functions for consistent and comprehensive analysis of risk behaviors of investment vehicle managers.

Systems and methods for objectively assessing operational due diligence (ODD) of an investment vehicle manager include providing, to each of a population of managers, an electronically-fillable questionnaire including a number of questions regarding risk factors, each risk factor belonging to one of a number of practice aspects, each question requiring selection from a number of standardized answer options. The answers collected from the number of managers may be combined to identify a propensity for exhibiting each of the number of risk factors across portions of the manager population. Each manager may be benchmarked against the propensity of manager population(s) and/or a peer group thereof to provide an objective assessment of manager performance and, in combination, portfolio performance in relation to real world common practices. Results of analysis and benchmarking may be provided in an interactive report for review.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a block diagram of an operation assessment platform and environment for conducting operational due diligence assessments and evaluating data derived therefrom; and

FIGS. 2A through 2D illustrate example screen shots of portions of a manager report detailing operational due diligence and risk analysis of a manager, in accordance with an embodiment of the present disclosure;

FIG. 2E illustrates an example screen shot of a portion of a manager report presenting a regulatory information assessment, in accordance with an embodiment of the disclosure;

FIGS. 3A-3B, 4A-4D, 5A-5B, 6A-6C, and 7A-7B illustrate example screen shots of portions of a portfolio report detailing operational due diligence and risk analysis of a set of managers of the investment vehicles held by a client in a client portfolio, in accordance with an embodiment of the present disclosure;

FIGS. 8A and 8B are a swim lane diagram of an example process for obtaining and analyzing survey answers presented to an investment vehicle manager;

FIGS. 9A and 9B are flow charts of example methods for benchmarking investment vehicle managers using risk data derived from standardized survey answers;

FIG. 10A is an operational flow diagram of an example process for automatically generating benchmark metrics for use in an ODD report;

FIG. 10B is an operational flow diagram of an example process for customizing report information with evaluator commentary and generating the ODD report for user review;

FIG. 11 is a flow chart of an example method for analyzing trends in automatically generated benchmark metrics associated with ODD assessments conducted over a period of time; and

FIG. 12 and FIG. 13 illustrate example computing systems on which the processes described herein can be implemented.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

In some implementations, systems and methods described herein assist in identifying and quantifying operational risks within investment managers or specific investment products. The systems and methods rely upon structured survey data including questions linked to bounded and/or limited choice answers to support comparison to other survey takers. The questions may be directed to a variety of risk factors, each risk factor corresponding to one or more policies, procedures, and/or capabilities across an entity's organizational and/or operational structure. Conversely, the limited and/or bounded range of answers for each question may be characterized, using a set of rules, to identify the respondent's selection as being either a preferred (e.g., supportive of best practices) or a non-preferred (e.g., an exception to best practices) response.

In some implementations, the responses to the structured survey data collected from a population of respondents are analyzed to determine the commonality among respondents to fail to follow a best practice (e.g., a propensity to indicate an exception to best practice in response to any give question of the survey questions). In this manner, the systems and methods described herein provide an additional layer of knowledge to participants in the structured survey, assisting participants in recognizing not only divergence from best practices but also deviations from standard market practices. Thus, certain exceptions to best practices as defined in the survey data may, in actual practice, fail to comport with common marketplace risk mitigation practices. Therefore, a participant may utilize both the identification of exceptions to best practices as well as deviations from standard market practices in making internal decisions regarding risk tolerance or underwriting standards. In some implementations, the survey outcome is presented in a report format. The report may be a printed report or an interactive online report providing the user the ability to drill down, sort, and/or filter the information to glean insights. Different report formats may be provided depending upon the participant industry, the end user audience, the participant geography, or other factors. The aforementioned factors, in some embodiments, are used to limit marketplace comparisons from the entire participant population (e.g., the “universe”) to a peer pool of participants similar to a target participant (e.g., in industry, size, geographical region, etc.).

The questions and/or rules may vary over time. For example, as additional cyber security mechanisms are released, previous best practices (e.g., 8-character passwords) may be viewed instead as risk factors in need of upgrading to the latest best practices (e.g., two-level authentication). As more questions and corresponding rules are added, in some implementations, comparisons can be made between participants, and trends can be analyzed across time for a given participant, by accessing partial survey data in a manner that supports an apples-to-apples comparison. For example, the questions, rules, and answer options may be linked within a database or data network structure to maintain associations while the survey data adjusts and expands over time.

Risk analysis surveys are commonly left at least partially blank, with a number of questions unanswered. In some implementations, the systems and methods described herein support comparisons between participants while also identifying sections of missing information. Further, the completeness of survey data of a given participant may be benchmarked against survey completeness across a peer group and/or the universe of participants of the platform. In supporting these comparisons across a marketplace, individual participants may recognize areas needing improvement. Conversely, participants may find competitive advantage in being able to demonstrate high conformance to best practices, risk mitigation that exceeds peer standards, and commitment to survey diligence that exceeds market practice.

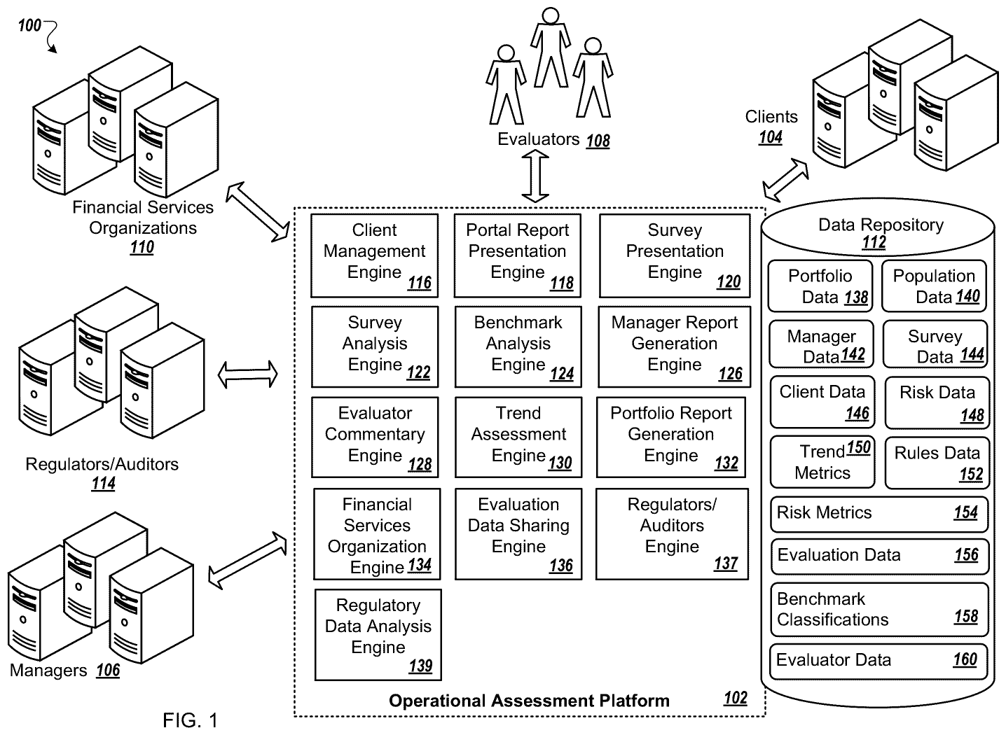

Turning to FIG. 1, an operation assessment platform 102 and environment 100 for conducting operational due diligence assessments and evaluating data derived therefrom, in some implementations, automates provision of operational due diligence surveys to investment vehicle managers 106, analyzes the results, provides a platform for evaluators 108 to include manual review summaries and notes regarding the analysis, and shares the results with clients 104 and/or financial services organizations 110 for use in intelligently selecting managers for investment vehicles included in investment portfolios. The managers 106 may include publicly traded investment vehicles and/or private market investment vehicles. Although described in relation to managers 106, in some embodiments, the managers 106 include other entities. For example, at least a portion of the capabilities of the systems and methods described herein are also applicable to asset owners wishing to review whether best practices are being met by the organization. Further, in some embodiments, service providers, in addition to or instead of investment vehicle managers, may obtain review for best practices using a portion of the due diligence assessments (e.g., unrelated to investments) described herein. The operational assessment platform 102 may include a data repository 112 (e.g., one or more computer readable data storage elements or systems either co-located or distributed via a network) for collecting both raw data (e.g., survey data 144) and data derived through analysis. Further, the data repository 112 may store information regarding the various entities and users accessing the operational assessment platform 102, such as manager data 142 regarding the managers 106, financial services organizations data 156 regarding the financial services organizations 110, client data 146 regarding the clients 104, and evaluators data 160 regarding the evaluators 108.

In some implementations, a survey presentation engine 120 enables automated presentation of an operational due diligence questionnaire to each of the managers 106 to collect information regarding operational risk management applied by the managers 106 in areas of both investment strategy and firm management strategy. In some examples, management-level questions may relate to the due diligence (risk) aspects of governance, technology and cyber security, and back office functions. Conversely, investment strategy-level questions may include a variety of questions relating to a number of investment strategies managed by the manager such as, in some examples, a fixed-income strategy, an equity strategy, and a hedge fund strategy. The questions, for example, may include the risk aspects of vendor management and trade settlement. While the survey presentation engine 120 may present the same questions repeatedly to obtain information regarding each investment strategy, the management-level questions need only be presented once.

The survey presentation engine 120, in some implementations, presents discrete answer options related to each question. To provide for the ability to conduct comparisons between the strategies and behaviors of various managers 106, for example, each manager is provided limited standardized answer options related to each question (e.g., a yes/no, drop-down menu, or numeric answer, etc.). Further, in some embodiments, for at least a portion of the survey questions, the manager 106 may be provided the opportunity to qualify the selection of the standardized answer option with a brief comment. The brief comments, for example, may be reviewed by evaluators 108 in refining an automated evaluation generated by a survey analysis engine 122.

The managers 106, in an illustrative embodiment, may be invited to log into the operational assessment platform 102 to answer survey questions presented by the survey presentation engine 120 via a portal or web site interface. Manager data 142 may guide the survey presentation engine 120 in which sets of questions to present (e.g., which investment strategies to cover). Alternatively, the managers 106 may be requested to identify and provide information for each investment strategy area offered by the manager. The survey presentation engine 120 may include alternate branches based upon answers provided to certain questions. For example, after identifying whether the manager is using a managed account or a commingled fund, follow-on questions related to the particular type of accounting used may be presented. The survey presentation engine 120, in another example, may include alternate branches based upon the manager's practice (e.g., firm size, practice type, etc.).

Upon submitting answers, each answer may be stored in the data repository 112 as survey data 144. The survey data 144 may be assigned a date to identify the recency of data collection. For example, questions may adapt as best practices change (e.g., technological advances, shifts in human resource requirements, etc.). Thus, the date (timestamp) may be keyed to a particular set, or version, of questions. Further, the survey data 144 may include multiple sets of responses for various managers 106 to track trends in individual managers 106 over time (e.g., movement away or toward best practices compliance).

In some implementations, the managers 106 are invited to take surveys by the operational assessment platform 102 on a regular schedule. The schedule may depend, in part, on the type of manager. For example, a large institutional manager running an equity long-only strategy may be invited to respond on a less frequent schedule (e.g., every other year, every third year, etc.), while a small hedge fund manager may be invited to respond on a more frequent schedule (e.g., every 6 months, every year, etc.). Frequency of collection of survey information may depend, in part, on requirements placed by regulators or auditors 114, expectations or demands of clients 104, or the outcome of analysis by an individual manager's responses as determined by a benchmark analysis engine 124. For example, if a particular manager demonstrated a significantly larger number of risk areas than the typical manager 106, the manager may be approached regarding adoption of certain risk management practices and a follow-on survey may be provided by the survey presentation engine 120 to determine whether improvements have been made. In some embodiments, survey data collection may be triggered by certain risk factors identified through regulatory data analysis via the regulatory data analysis engine 139, described below. In another example, the frequency of survey may be increased based on certain risk factors identified through regulatory data analysis. Further, in some implementations, a full survey may be presented less frequently, while targeted surveys directed to more sensitive risk areas, such as cyber security, may be presented more often.

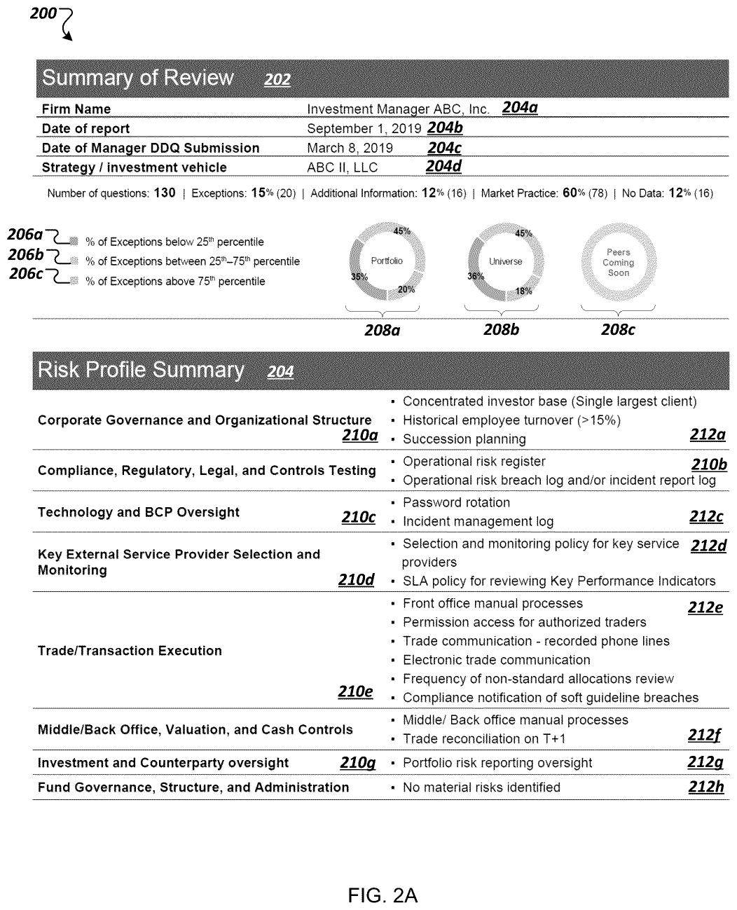

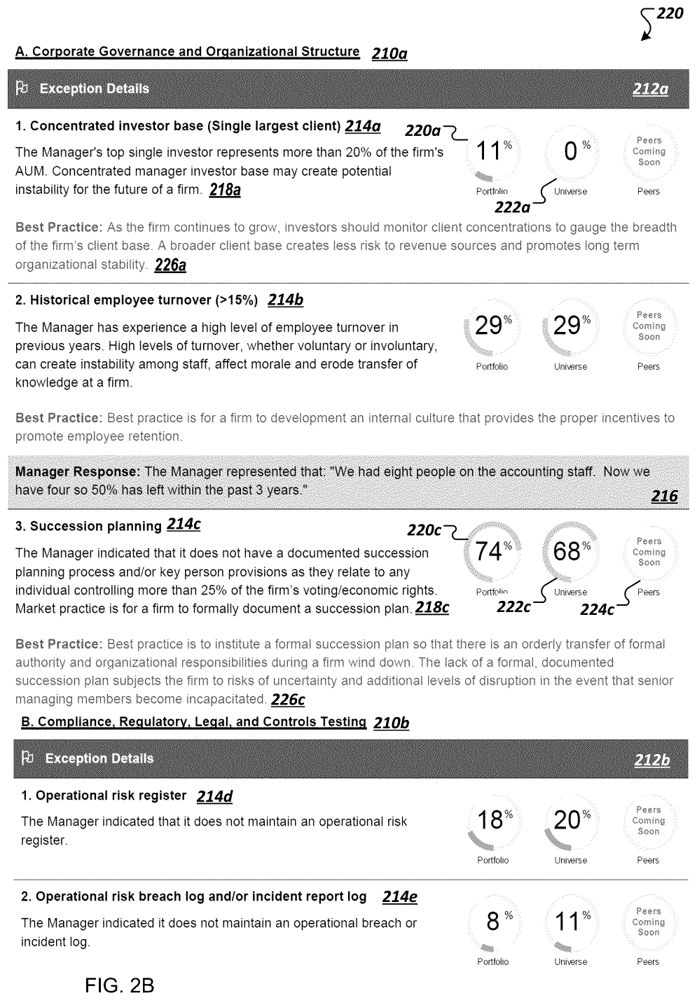

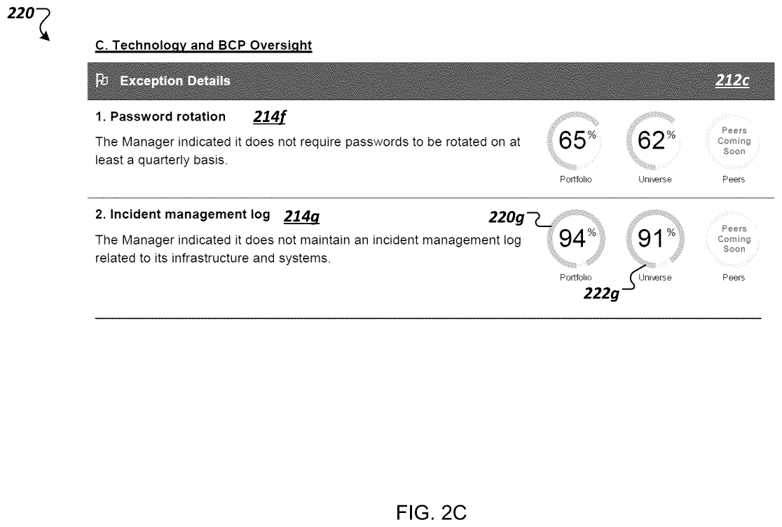

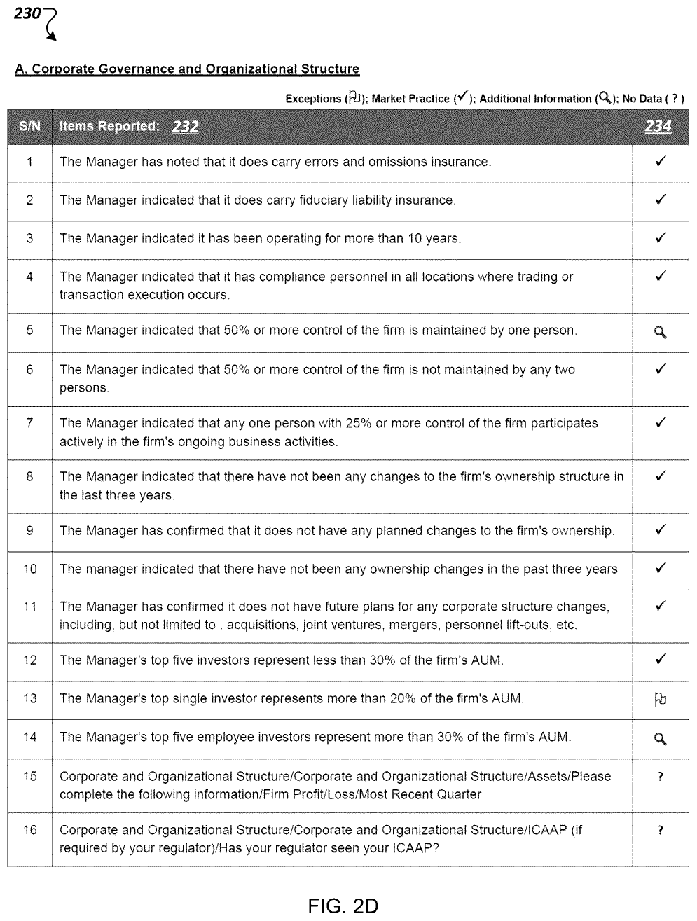

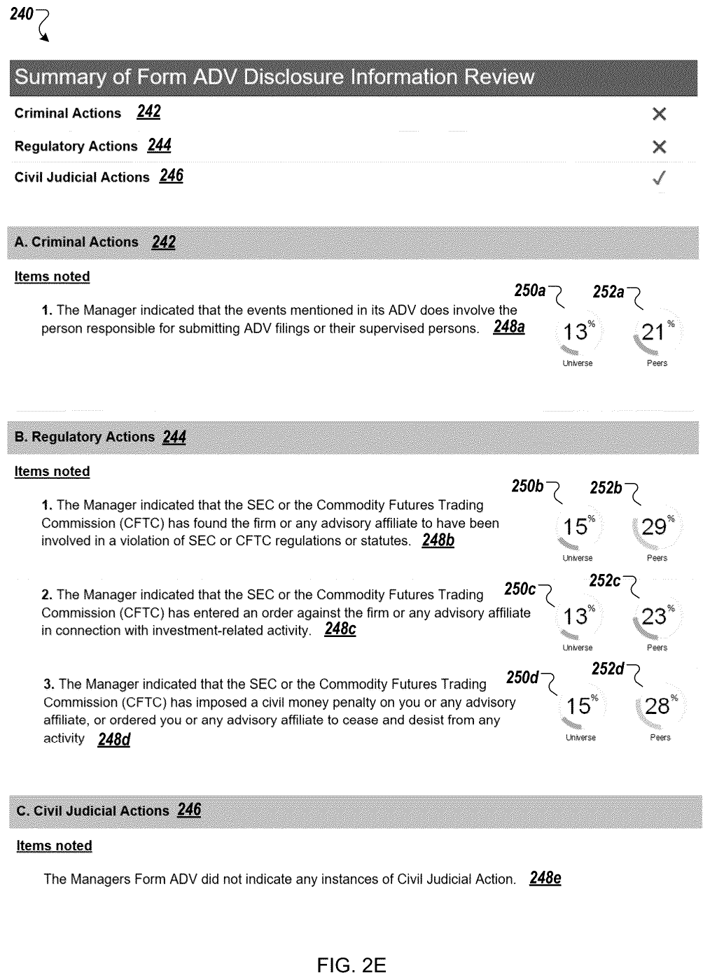

Regardless of how the survey data is collected, the most recent survey data 144 collected from a manager 106 by the survey presentation engine 120 may be used by the survey analysis engine 122 to identify areas of potential risk in the manager's practices. The survey analysis engine 122, for example, may identify a number of answers provided by the manager 106 indicative of risk. In some embodiments, the survey analysis engine 122 applies rules data 152 to flag certain answers as being indicative of risk. The rules data 152 may include various analysis factors in identifying risk, such as binary factors (e.g., answer “no” to question #3 is indicative of risk), range factors (e.g., if the numeric value of the answer to question #56 is less than 5, etc.), and/or combination factors (e.g., if the answer to question #41 is “no” and the answer to question #5 is greater than 1,000 it is indicative of risk, etc.). The survey analysis engine 122 may output risk data 148 identifying areas of risk exhibited in the answers provided by the manager 106 through the survey presentation engine 120. Examples of risks identified in a number of risk aspects 210 are illustrated in a risk profile summary 204 of FIG. 2A.

In some implementations, in addition to survey data, regulatory data is imported from one or more regulatory data sources (e.g., from regulators and/or auditors 114) and formatted for use as a portion of the risk data 148. For example, a regulatory data analysis engine 139 may import Securities and Exchange Commission (SEC) form ADV information, such as information regarding criminal actions, regulatory actions, and/or civil judicial actions, and/or data from other regulatory authorities. The regulatory data analysis engine 139, similar to the survey analysis engine 122, applies rules data 152 to flag certain data derived from the imported regulatory data as being indicative of risk. The rules data 152 may include various analysis factors in identifying risk, such as binary factors (e.g., existence of an identified criminal action in the ADV disclosure information), range factors (e.g., categories of civil monetary penalties, etc.), and/or combination factors (e.g., a regulatory action related to violation of a statute in combination with a cease and desist, etc.). The regulatory data analysis engine 139 may output risk data 148 identifying areas of risk exhibited in the information obtained from one or more regulatory data sources.

In some implementations, the risk data 148 generated by the survey analysis engine 122 and/or the regulatory data analysis engine 139 is provided to a benchmark analysis engine 124 for benchmarking against other managers 106. The benchmark analysis engine 124 may combine risk data 148 from groupings of managers 106 to identify propensity among the groupings of managers 106 for exhibiting the same risk factor(s) as the evaluated manager. This allows the operational assessment platform 102 to consider industry norms in addition to simply presenting non-compliance with various practices identified, in some examples, by regulators and auditors 114, clients 104, or representatives of industry leaders in the managers 106 as best practices for risk mitigation. Non-compliance with individual practices, in some examples, may relate to expense of applying the practice, difficulty in obtaining internal compliance with the practice, and/or incremental technological advances required in advance of being capable of complying with the practice (e.g., adoption of the practice by software platforms used by the various managers, etc.). Thus, non-compliance may be common throughout the managers 106 or portions thereof.

The groupings of managers 106, in some examples, can include all managers 106 for which data is available (referred to herein as “the universe”), managers 106 in the same type of industry (e.g., public, private, sub-categories thereof), managers 106 of investment vehicles held within the portfolio of a requesting client 104 (referred to herein as “the portfolio”), or similar managers to a manager under evaluation (referred to herein as “peers”). In evaluating a manager against the managers' peers, one or more characteristics of the evaluated manager may be used to filter the universe of the managers 106 to only those managers 106 having matching characteristics to the evaluated manager. The characteristics may include, in some examples, similarity in investment vehicles (e.g., matching investment strategies), geographic region of the managers, size of the managers, and/or length of time in business (e.g., manager maturity). In some embodiments, users of the operational assessment platform 102, such as the clients 104 and regulators/auditors 114, may select characteristics for identifying peer sets of the managers 106. The peers, in part, may depend upon a threshold number of managers 106 exhibiting the selected characteristics (e.g., at least 20, at least 50, etc.) so that valuable trend analysis is provided and, conversely, behaviors of particular managers is not discoverable through narrow characteristic selections. The benchmark analysis engine 124, in some implementations, accesses population data to identify managers 106 sharing similar characteristics. Alternatively, the benchmark analysis engine 124 may access manager data 142 to filter on the various characteristics to identify similar managers to the evaluated manager 106.

The benchmark analysis engine 124, in some embodiments, obtains data during a recent timeframe, for example to avoid a false analysis based upon movements within the industry toward risk compliance in various areas. In one example, the recency may be set at a one-year period. In other examples, the recency may be set at eighteen months, two years, or three years. Recency, in some embodiments, may be based in part upon intended audience. For example, the regulators and auditors 114 may have specific desired timeframes, while an evaluation for use in presenting to managers 106 or clients 104 may have a different desired timeframe.

The benchmark analysis engine 124, in some implementations, analyzes risk data 148 of the grouping of managers to identify a portion of the managers 106 within the selected grouping of managers 106 that responded similarly to the evaluated manager 106 for each risk factor identified by the survey analysis engine 122. In some embodiments, the benchmark analysis engine 124 accesses benchmark classifications 158 to determine a quantile classification to apply to the selected grouping of managers 106 in determining deviance or similarity of the response of the evaluated manager 106 to the typical response of the selected grouping of managers 106. The quantile classification, in some examples, can include a tercile classification, a quartile classification, a decile classification, a percentile classification, or other quantile classification. In other embodiments, the quantile classification may depend in part upon a requestor of the comparative analysis. For example, one of the clients 104 may wish to review tercile classifications of the managers 106 in the client's portfolio (e.g., as identified via portfolio data 138 of the data repository 112), while a financial services organization 110 may wish to review quantile classifications of a grouping of the managers 106.

In some implementations, a trend assessment engine 130 obtains risk metrics 154 from the benchmark analysis engine 124 and generates trend metrics 150 regarding trends in manager application of various risk mitigation practices. The trend assessment engine 130, for example, may compare historic risk metrics 154 to present risk metrics 154 to identify movement in adoption of the various risk mitigation practices covered within the survey questions presented by the survey presentation engine 120. The trend metrics 150 identified by the trend assessment engine 130, for example, may be used to educate the managers 106 on movement within the industry toward or away from certain risk mitigation practices. In some embodiments, similar to the risk metrics 154, the trend metrics 150 may be developed for different peer groupings of managers 106 as well as for different quantile classifications.

In some implementations, a user (e.g., client 104, regulator/auditor 114, financial service organization 110, or manager 106) accesses the operational assessment platform 102 to obtain a report on one or more managers. A manager report generation engine 126, for example, may be used to generate information regarding a certain manager 106, based on the survey data 144 and/or regulatory data collected regarding the manager 106. The manager report generation engine 126, in addition to accessing and formatting survey data 144 related to a requested manager 106, may execute the benchmark analysis engine 124 in real time to obtain a statistical analysis of the manager's performance in relation to other managers 106 in the operational assessment environment 100 at the time of the request. Further, the manager report generation engine 126 may execute the trend assessment engine 130 in real time (e.g., in the circumstance of a report request targeting a manager 106 audience or a regulator/auditor 114 audience) to enable comparisons between the manager's performance and current movements in practices of sets of managers 106.

In some implementations, the manager report generation engine 126, after gathering automated analysis via the operational assessment platform 102, causes execution of an evaluator commentary engine 128 to obtain manual review and commentary prepared by one of the evaluators 108. The evaluator commentary engine 128, for example, may assign one of the evaluators 108 to review the automatically generated report data prepared by the manager report generation engine 126 and to add evaluator data 160 that the manager report generation engine 126 can use in formatting a final report structure. The evaluators 108, for example, may be provided a graphical user interface by a portal report presentation engine 118 to review information and to add comments thereto.

In addition to reviewing the automatically generated report data, in some embodiments, the evaluators 108 conduct interviews with personnel of each manager 106 being evaluated to clarify brief written responses or to obtain additional information regarding the manager 106. The interviews, in some implementations, extend beyond the managers 106 themselves to key partnerships, such as service providers, vendors, or contractors having relationships with the manager 106 which can expose the manager 106 to risk. In some embodiments, answers to one or more questions regarding risk factors involving these key partnerships may be filled in by the evaluators 108 rather than by the managers 106.

The manager report generation engine 126, in some implementations, generates a formatted report for review by the requesting entity (e.g., client 104, manager 106, or regulator/auditor 114). The report, in some examples, may be provided in a document format (e.g., Word document, PDF, etc.) or as interactive content available to review online via a portal report presentation engine 118. For example, the requesting entity may log into the operational assessment platform to review report information. The client management engine 116 or regulators/auditors engine 137, in some examples, may enable access to the operational assessment platform for report generation requests and for report review.

In an illustrative example, the manager report prepared by the manager report generation engine 126 may include formatted information as presented in a series of example screen shots of FIGS. 2A-2D. Turning to FIG. 2A, an example screen shot 200 illustrates a summary review section 202 presenting information pertaining to an investment vehicle manager 204a as well as the risk profile summary section 204 identifying practice areas 210 where the manager 204a has demonstrated material risk in the provided answers to the manager survey. The summary review section 202 presents a date of the report 204b, a date of submission of the survey answers 104c, and a strategy/investment vehicle 204d managed by the manager 204a. Although only listing one strategy/investment vehicle 204d, in other embodiments, multiple strategy/investment vehicles may be presented for an individual manager such as the manager 204a.

The summary review section 202 additionally provides a quartile analysis key 206 and quartile analysis example graphics 208 illustrating a color-coded quartile circle graphic. The percent of exceptions above the 75th percentile is color-coded green (e.g., the lack of risk mitigation for this survey response practice is common in the universe of managers as illustrated in graphic 108b, in the client's portfolio as illustrated in graphic 208a, or among the manager's peers as illustrated in graphic 208c). The percent of exceptions between the 25^{th} and the 75^{th} percentile is color-coded yellow (e.g., the lack of risk mitigation for this survey response practice is somewhat common but not widely adopted in the universe of managers as illustrated in graphic 208b, in the client's portfolio as illustrated in graphic 208a, or among the manager's peers as illustrated in graphic 208c). The percent of exceptions below the 25th percentile is color-coded red (e.g., the lack of risk mitigation for this survey response practice is uncommon in the universe of managers as illustrated in graphic 208b, in the client's portfolio as illustrated in graphic 208a, or among the manager's peers as illustrated in graphic 208c). In other embodiments, the graphics may differ (e.g., bar graphs vs. circle graphs or pie charts) and/or the quantiles may differ based upon desired output.

Turning to the risk profile summary section 204, on the left hand side, risk aspects 210 of the firm's practice are listed: corporate governance and organizational structure; compliance, regulatory, legal, and controls testing; technology and business continuity planning (BCP) oversight; key external service provider selection and monitoring; trade/transaction execution; middle/back office, valuation, and cash controls; investment and counterparty oversight; and fund governance, structure, and administration. On the right hand side, particular risk identifiers 212 are listed for each risk aspect. The risk identifiers, for example, may represent a question presented in the manager survey or the outcome of a combination of questions. Regarding the risk aspect of fund governance, structure, and administration 210h, the corresponding risk identifier 212h reads “no material risks identified”, demonstrating that the manager 204a is fully in compliance regarding the risk aspect 210h. In relation to privately traded investment vehicles, in some embodiments, the firm risk aspects may include, in some examples, corporate governance and organizational structure; regulation, compliance, and audit; investment and counterparty oversight; technology and BCP oversight; key external service provider selection and monitoring; trade/transaction execution; valuation and cash controls; and fund governance and administration.

In FIGS. 2B and 2C, an example risk aspect detail analysis screen shot 220 illustrates, for both the corporate governance and organization structure risk aspect 210a, the compliance, regulatory, legal, and controls testing risk aspect 210b, related exception details 212a, 212b, and 212c. The exception details 212a, 212b, and 212c demonstrate, for both a client portfolio population and for the universe of managers population, quartile comparisons of various risk factors 214 for the manager 204a.

Regarding an historical employee turnover risk factor 214b, a manager response 216 explains this discrepancy in risk mitigation by informing the audience that the organization has reduced accounting staff by half, perhaps due to efficiencies derived through automation. In some embodiments, one of the evaluators 108 may selectively include manager comments where useful or not confidential through the evaluator commentary engine 128 (e.g., as evaluation data 156). In other embodiments, manager comments collected by the survey presentation engine 120 along with certain standardized answer selections may be automatically included in the report by the manager report generation engine 126.

Regarding a succession planning risk factor 214c, although according to a brief description 218c the “market practice is for a firm to formally document a succession plan”, according to both a portfolio quartile analysis graphic 220c and a universe quartile analysis graphic 222c, a majority of managers in both the client's portfolio and in the managers 106 evaluated by the operational assessment platform 102, managers more often than not do not formally document a succession plan. This advises the client that this risk mitigation practice is less common in the marketplace as of the time of the report. Conversely, regarding the concentrated investor base risk factor 214a, the risk factor is extremely unusual in the universe of managers according to a universe graphic 222a (e.g., 0% or less than 1%) and most likely the only manager in the client's portfolio exhibiting this behavior according to a portfolio graphic 220a (e.g., 11%).

In some embodiments, where the report is instead generated for the benefit of one of the managers 106 rather than for one of the clients 104 of FIG. 1, the portfolio graphics 220 would not exist, but the universe graphics 222 and peers graphics 224 could be used to demonstrate to the manager under review that the manager's practices are in the minority of the universe 222c and, thus, may be becoming outdated. This could encourage the manager to update practices to appear progressive to potential clients 104. Further, a best practice explanation 226 may be presented for the manager's benefit, identifying why joining the majority of managers in creating a formal succession plan is a good idea (e.g., “The lack of a formal, documented succession plan subjects the firm to risks of uncertainty and additional levels of disruption in the event that senior managing members become incapacitated.”).

Turning to FIG. 2C, regarding an incident management log risk factor 214g, although maintaining an incident management log related to a manager's infrastructure and systems is identified as a risk mitigation factor, a portfolio quartile analysis graphic 220g and a universe quartile analysis graphic 222g each demonstrate a vast majority of managers 106 do not follow this practice (e.g., 94% and 91%, respectively). Thus, the comparative analysis for the risk factor 214g is colored green, assuring the reviewing client that failure to maintain an incident management log is in fact common industry practice at the time of the report.

FIG. 2D illustrates an example survey response detail screen shot 230 enumerating individual survey risk factors 232 and graphics 234 indicating whether the manager is compliant with market practice (a check graphic in the right column) or demonstrates an exception (a flag in the right column). Further, certain risk factors are marked with graphic 234 indicating that additional information is available. For example, upon selection of a magnifying glass icon, the reviewer (e.g., client representative) may be presented with additional information such as the manager's comment related to the risk factor. With other risk factors, the graphic 234 is a question mark, indicating that no data is available related to that question. The survey may lack data for a number of reasons including, in some examples, the question is not relevant to the particular manager, the manager skipped the question, or the question did not exist within the survey when the manager answered the questions.

Turning to FIG. 2E, a summary of SEC form ADV disclosure information review 240 presents information regarding criminal actions 242, regulatory actions 244, and civil judicial actions 246. The information, for example, may be gleaned from responses submitted by the manager in the disclosure information section of the SEC ADV form. The regulatory data analysis engine 139, for example, may have imported the form, generated a machine-readable format of the form, and identified responses corresponding to a number of risk data elements (e.g., such as in risk data 148).

Returning to FIG. 1, in some implementations, a portfolio report generation engine 132 generates a portfolio report including information on each manager in the portfolio of a requesting client 104 that has completed a survey through the operational assessment platform 102. The portfolio report generation engine 132, for example, may call upon the manager report generation engine 126 for each manager included in portfolio data 138 related to the requesting client 104. The manager report generation engine 126, in some implementations, further calls upon the benchmark analysis engine 124 to benchmark information related to the portfolio's managers as a whole (e.g., portfolio-level risk metrics 154) in comparison to the universe of managers 106, managers within the portfolio, and/or peer groupings of the managers 106, as discussed above. The outcome of the manager report generation engine 126, in some examples, may be provided in a document format (e.g., Word document, PDF, etc.) or as interactive content available to review online via a portal report presentation engine 118.

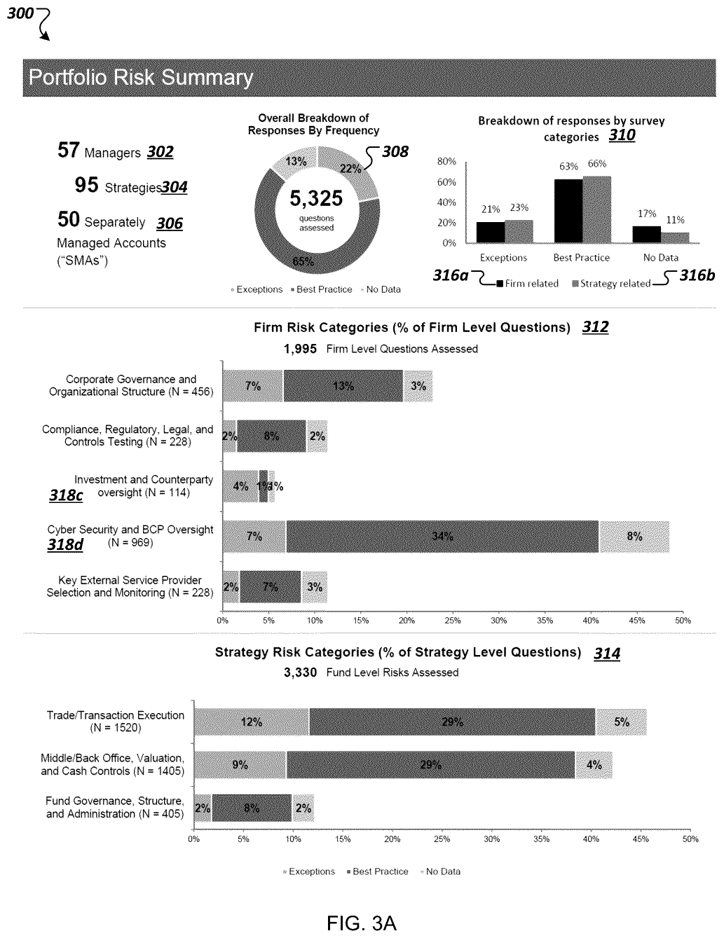

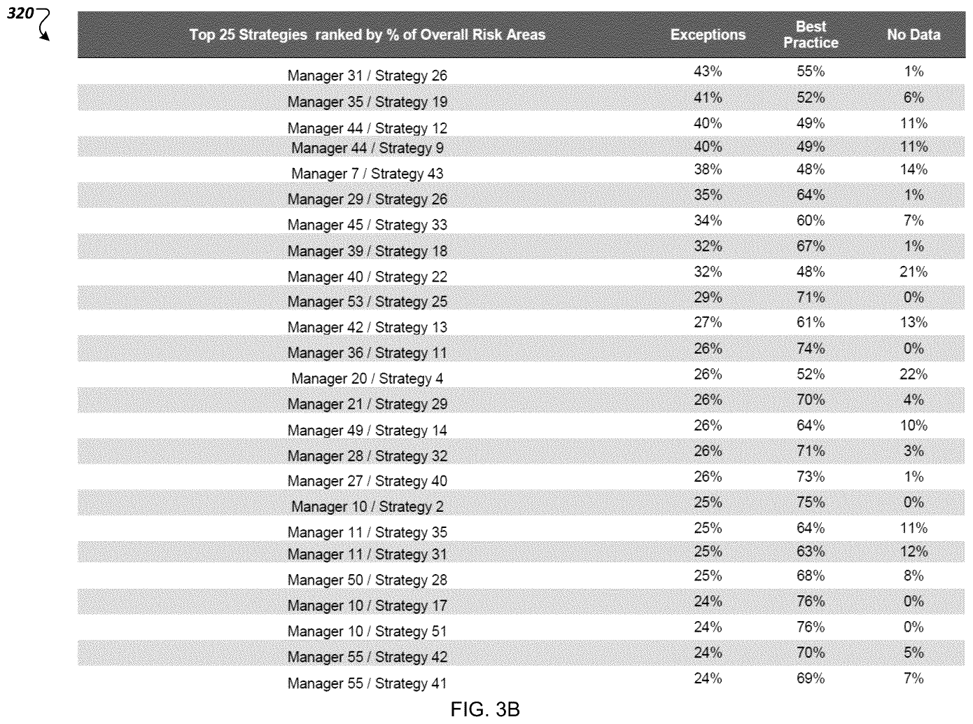

In an illustrative example, the portfolio report prepared by the portfolio report generation engine 132 may include formatted information as presented in a series of screen shots of FIGS. 3A-3B, 4A-4B, 5A-5B, 6A-6C, and 7A-7B.

Turning to FIG. 3A, a screen shot 300 of an example portfolio risk summary identifies that fifty-seven managers 302 have been analyzed, covering ninety-five strategies 304 and fifty separately managed accounts (SMA) 306. In some embodiments, the ODD assessment systems and methods of the present disclosure track not only investment strategies but also the structure of the investment's implementation (e.g., via a commingled fund or a separately managed account), because operational considerations will be different depending on how the investment strategy is implemented. This may lead to differing questions presented to the manager within the automated survey to capture unique risk factors of the investment strategies related to the investment's structure.

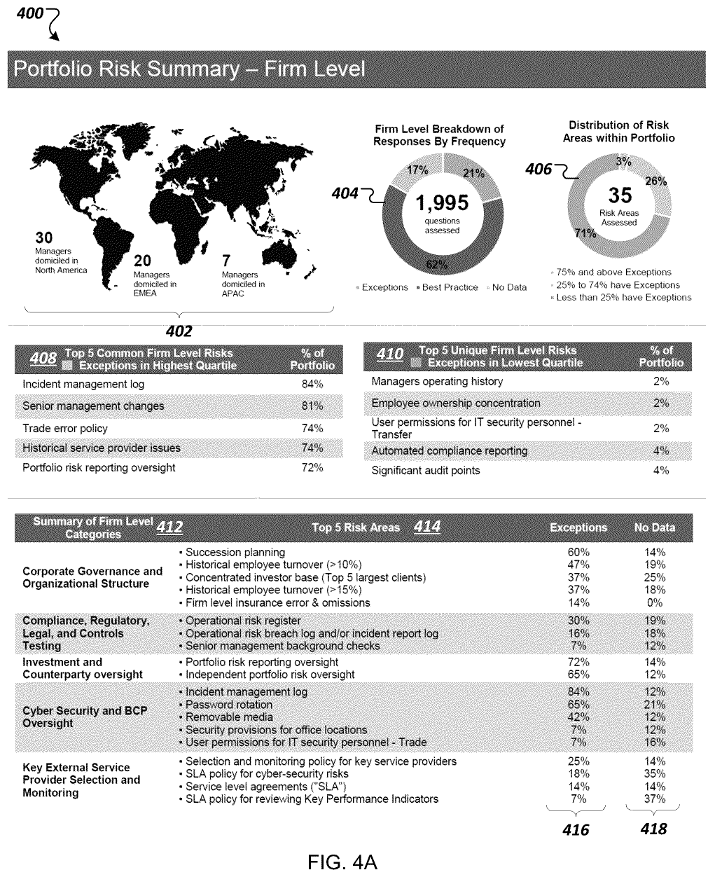

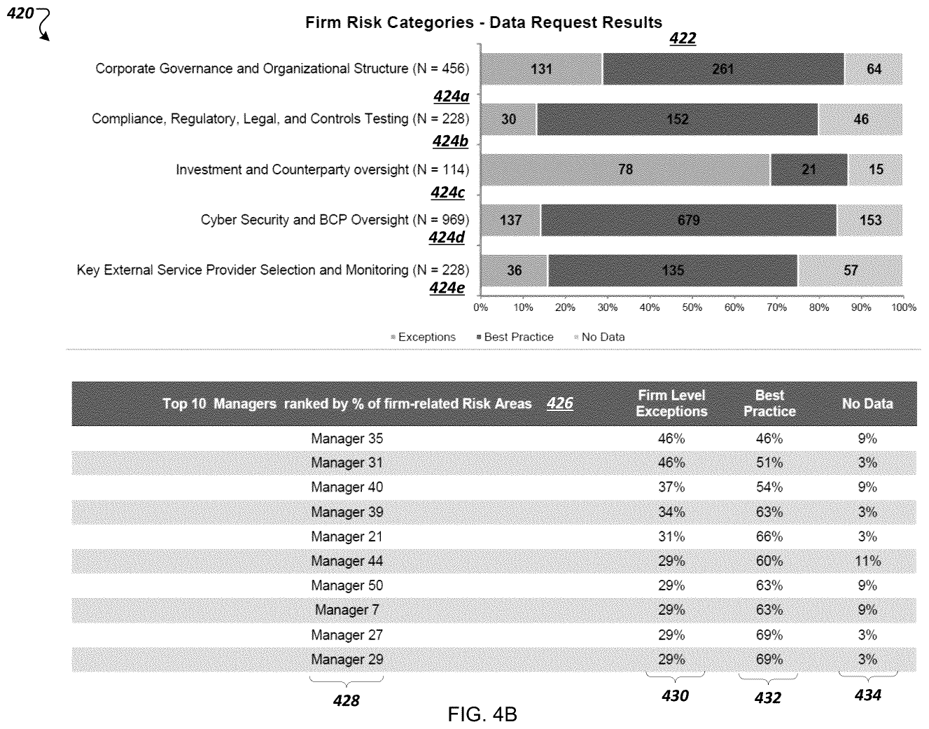

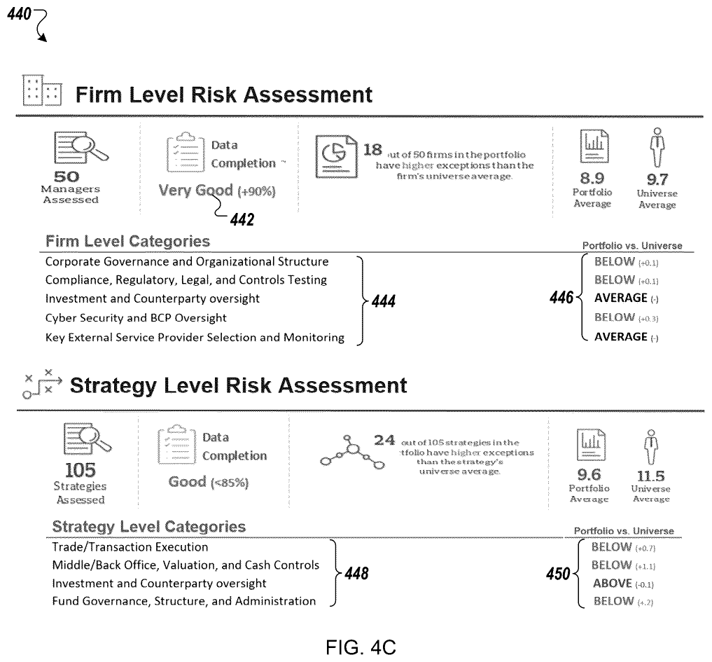

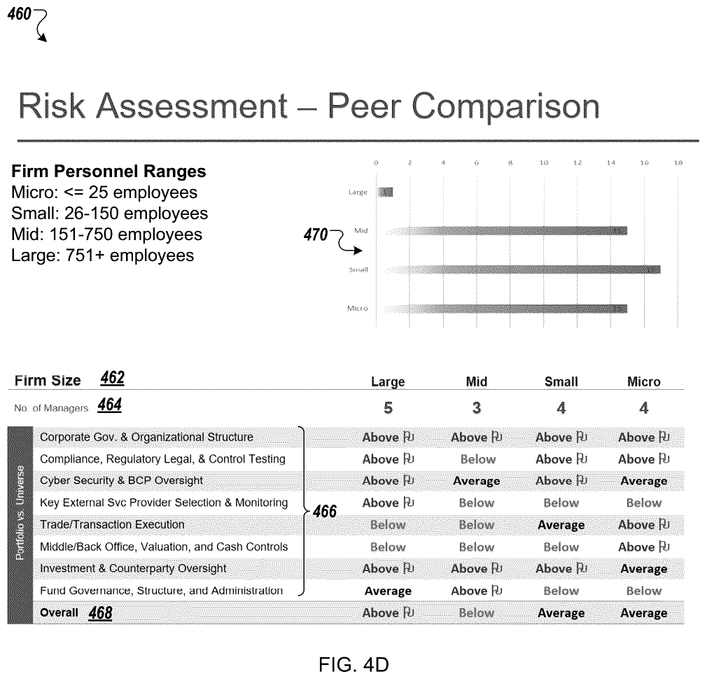

The portfolio risk summary screen shot 300 includes an overall breakdown circle graph 308 illustrates that, of 5,325 questions assessed across the fifty-seven managers 302, 65% demonstrated managers 302 conforming to best practices, 22% identified exceptions from best practice behaviors, and 13% of the questions contained no data (e.g., unanswered, irrelevant to one or more managers 302, etc.). A breakdown of responses by survey categories bar graph 310 illustrates exceptions, best, practices, and no data related to both firm related questions 316a and strategy related questions 316b. As illustrated in the bar graph 310, the “no data” category is higher for firm related questions 316a than for strategy related questions 316b, resulting in larger percentages of exceptions and larger percentages of best practices in strategy-related questions. This may be because some managers 302 may be less inclined to answer questions regarding the firm's management, viewing some questions as covering confidential information. In other presentations, the data completion itself may be assessed. For example, the data completion may be separated into quantiles (e.g., excellent, very good, above average, good, average, below average, poor, very poor, etc.) based upon absolute numbers (e.g., a 95%+ completion rate is excellent, etc.) and/or in comparison to the universe and/or peer firms' completion data. Turning to FIG. 4C, for example, a data completion rating of “Very Good (+90%)” is presented at the top of an example risk assessment screen shot 440.

Returning to FIG. 3A, a middle pane 312 presents percentage of exceptions, best practices, and no data per firm risk categories (e.g., firm risk aspects), while a lower pane 314 presents percentage of exceptions, best practices, and no data per strategy risk categories (e.g., strategy risk aspects). The bar graphs in the panes 312 and 314 provide the reviewer with a general feel for compliance versus exceptions within the reviewed portfolio. Further, the bar graphs in the panes 312 and 314 provide the reviewer with a general feel for the breakdown of questions. For example, in the firm risk categories, a cyber security and BCP oversight category 318d contained nearly half of the firm risk category related questions. As illustrated, the only risk aspect not demonstrating greater percentage compliance than exceptions is an investment and counterparty oversight risk category 318c.

Turning to FIG. 3B, a screen shot 320 illustrates a table of strategies ranked by the overall percentage of risk areas (e.g., the top twenty-five manager-strategy combinations for exceptions). In an interactive portfolio-level report presented to a representative of the client via a browser or web portal interface, the individual manager-strategy combinations may be user-selectable to obtain greater level of detail regarding exceptions discovered during analysis of each manager-strategy combination. Further, the manager-strategy combinations may be rearrangeable, in an interactive report format, to organize, in some examples, by best-to-worst strategies ranked by overall risk areas, by percentage best practice, or by percentage no data.

FIG. 4A presents a screen shot 400 of portfolio risk summary at a firm level (e.g., an overview of analysis of questions related to firm risk aspects across the fifty-seven managers 302 of FIG. 3A). The screen shot 400 includes a geographic break-down of managers, globally (e.g., thirty in North America, twenty in EMEA, and seven in APAC). An overall breakdown circle graph 404 illustrates that, of 1,995 questions assessed across the fifty-seven managers 302, 62% demonstrated managers 302 conforming to best practices, 21% identified exceptions from best practice behaviors, and 17% of the questions contained no data (e.g., unanswered, irrelevant to one or more managers 302, etc.).

A distribution of risk areas within portfolio circle graph 406 identifies that three percent of the questions answered as exceptions were highest quartile answers (e.g., matching answers of 75% or above of the managers 302, twenty-six percent of the questions answered with exceptions were middle quartile answers (e.g., matching answers of 25-75% of the managers 302), and seventy-one percent of the questions answered with exceptions were lowest quartile answers (e.g., matching the answers of less than 25% of the managers 302). These exceptions are further broken down below, in a listing of the top five common firm level risks 408 (e.g., green color coded risks where the 75%+ majority of the managers reported an exception) and a list of the top five unique firm level risks 410 (e.g., red color coded risks where the <25% minority of managers reported an exception).

In a bottom pane, a summary of the risk categories 412 (e.g., risk aspects) along with top risk factors 414 in each risk category are presented. The percentage exceptions 416 in each, as well as the percentage of “no data” 418 in each, are further displayed. This synopsis is broken down further in the report, or further details may be accessed, in an online report, by selecting particular risk categories and/or risk areas.

Turning to FIG. 4C, as illustrated in the screen shot 440, in some implementations, portfolio risk summary information includes a summary rating 446 of each firm level risk category 444. The summary rating, for example, may provide a general assessment (e.g., excellent, very good, above average, good, average, below average, poor, very poor, etc.) of the category performance in relation to a comparator group (illustrated as the universe but, in other examples, may include a peer group, firm type group, or other subset of the universe of firms). As illustrated, each category 444 corresponds to a summary rating 446 of below, average, or above the comparative group (e.g., the universe). Further, as shown in the summary ratings 446, each general assessment may be qualified with a percentage points differentiator from the comparator group's average score. In an illustrative example, the illustrated firm, for risk category “Corporate Governance and Organizational Structure” 444a has demonstrated a below average summary rating 446a of over 10% below the manager universe average, while, for the risk category “Key External Service Provider Selection and Monitoring 444e, the illustrated firm has demonstrated an average summary rating 446e.

Turning to FIG. 4B, the firm level portfolio risk summary of FIG. 4A is now broken down into a screen shot 420 of answer assessments by firm risk categories 422: corporate governance and organizational structure 424a; compliance, regulatory, legal, and controls testing 424b; investment and counterparty oversight 424c; cyber security and BCP oversight 424d; and key external service provider selection and monitoring 424e. Each risk category 424 is presented as a bar of a bar chart, with a total number of questions (“N=X”) identified for each risk category 424. For example, out of the 456 questions related to corporate governance and organization structure risk category 424a, 131 of the answers to the questions were categorized (e.g., by the survey analysis engine 122 of FIG. 1) as exceptions, 261 of the answers to the questions were categorized as best practices, and 64 of the questions were categorized as “no data”. In some implementations, questions may be categorized as sets according to rules (e.g., the rules data 152) such that the categorization of answers to certain questions may be linked together. Thus, survey questions and corresponding risk factors do not always have a one-to-one correlation, according to certain embodiments. The bar graph is arranged along a 0 to 100% x-axis, such that the reviewer may visually estimate relative percentages from risk category to risk category 424 in addition to reviewing raw numbers.

The screen shot 420 further presents a table 426 of top ten managers 302 ranked by percentage exceptions in the firm risk categories 424 (e.g., percentage firm level exceptions 428, percentage best practice 430, and percentage no data 432). As with FIG. 3B, in an interactive portfolio-level report presented to a representative of the client via a browser or web portal interface, the individual managers listed in a manager column 428 may be user-selectable to obtain greater level of detail regarding exceptions discovered during analysis of each manager. Further, the presentation of the managers 428 may be rearrangeable, in an interactive report format, to organize, in some examples, by best-to-worst strategies ranked by firm level exceptions 430, by percentage best practice 432, or by percentage no data 434.

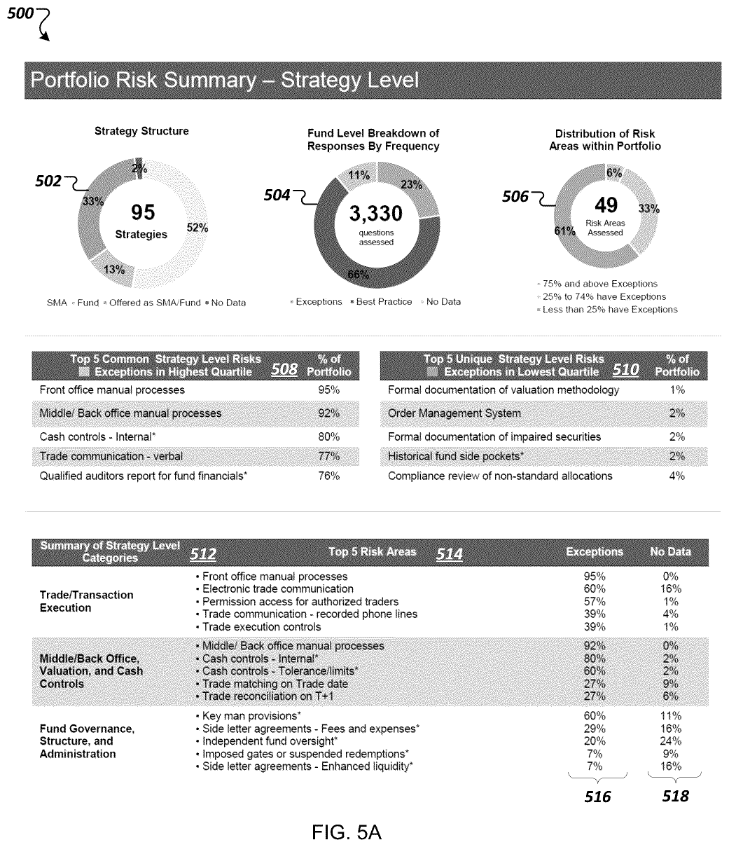

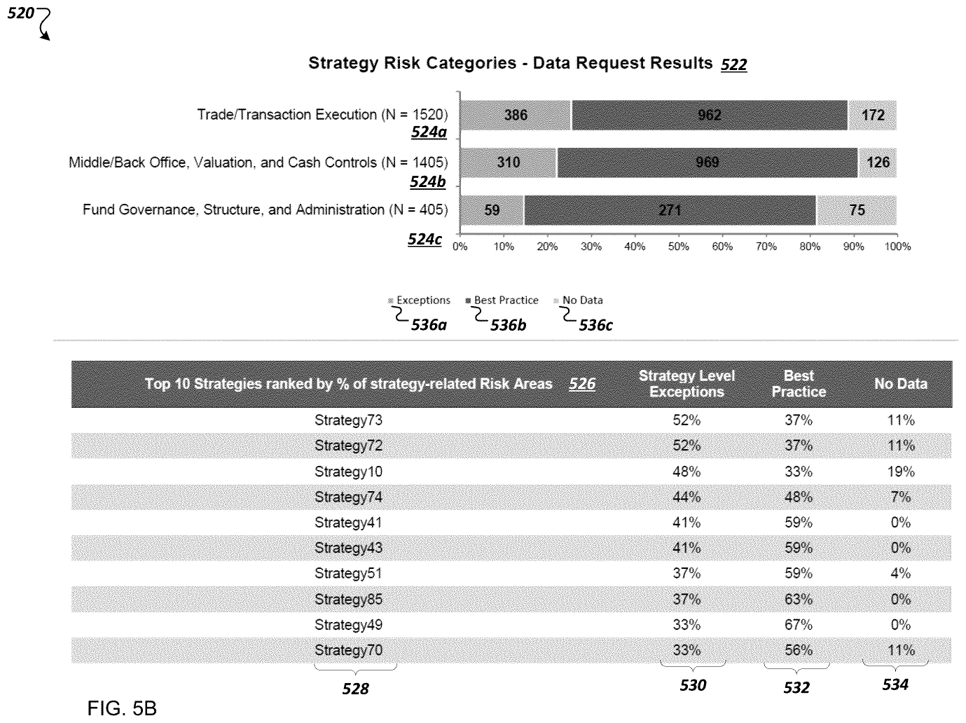

Similar to the portfolio risk summary at firm level screen shot 400 of FIG. 4A, FIG. 5A illustrates a portfolio risk summary at strategy level screen shot 500. A first circle graph 502 breaks down the strategies of the managers 302 of the portfolio into types of strategies (e.g., SMA, Fund, Offered as SMA/Fund, no data). Similar to the circle graph 404 of FIG. 4A, FIG. 5A includes an overall breakdown circle graph 504 illustrates that, of 3,330 questions assessed across the fifty-seven managers 302, 66% of the answers demonstrated that the corresponding managers 302 were conforming to best practices, 23% identified exceptions from best practice behaviors, and 11% of the questions contained no data (e.g., unanswered, irrelevant to one or more managers 302, etc.).

Additionally, in some implementations, the screen shot 420 may include comments provided by an evaluator 108 of FIG. 1 guiding analysis of the information presented in the screen shot 420. The comments, for example, may relate to contextual information or to assessment that is a product of subject matter expertise but is not embedded within the structured survey question and answer selection model.

Similar to the circle graph 406 of FIG. 4A, FIG. 5A includes a distribution of risk areas within portfolio circle graph 506 which identifies that six percent of the questions answered as exceptions were highest quartile answers (e.g., matching answers of 75% or above of the managers 302, thirty-three percent of the questions answered with exceptions were middle quartile answers (e.g., matching answers of 25-75% of the managers 302), and sixty-one percent of the questions answered with exceptions were lowest quartile answers (e.g., matching the answers of less than 25% of the managers 302). These exceptions are further broken down below, in a listing of the top five common strategy level risks 508 (e.g., green color coded risks where the 75%+ majority of the managers reported an exception) and a list of the top five unique strategy level risks 510 (e.g., red color coded risks where the <25% minority of managers reported an exception).

In a bottom pane, a summary of the top five risk categories 512 (e.g., risk aspects) along with top risk factors 514 in each risk category 512 are presented. The percentage exceptions 516 in each, as well as the percentage of “no data” 518 in each, are further displayed. This synopsis is broken down further in the report, or further details may be accessed, in an online report, by selecting particular risk categories and/or risk areas.

Further, turning to FIG. 4C, in some embodiments, strategy risk level assessment is presented with a summary rating 450 of each strategy level risk category 448. The summary rating 450, for example, may provide a general assessment (e.g., excellent, very good, above average, good, average, below average, poor, very poor, etc.) of the category performance in relation to a comparator group (illustrated as the universe but, in other examples, may include a peer group, firm type group, or other subset of the universe of firms). As illustrated, each category 448 corresponds to a summary rating 450 of below, average, or above the comparative group (e.g., the universe). Further, as shown in the summary ratings 450, each general assessment may be qualified with a percentage points differentiator from the comparator group's average score. In an illustrative example, the illustrated firm, for strategy level category “Investment and Counterparty oversight” 448c has demonstrated an above average summary rating 450c of over 10% above the manager universe average.

FIG. 5B, similar to FIG. 4B regarding firm-level risk, presents a break-down of the firm level portfolio risk summary of FIG. 5A into a screen shot 520 of answer assessments by strategy risk categories 522: trade/transaction execution 524a; middle-back office, valuation, and cash controls 524b; and fund governance, structure, and administration 524c. In further embodiments, for example in relation to privately traded investments, the strategy risk categories may include liquidity terms, investor concentration, net asset value (NAV) calculation procedures, prime brokerage and custody of assets, and cash controls and movement. Each risk category 524 is presented as a bar of a bar chart, with a total number of questions (“N=X”) identified for each risk category 524. For example, out of the 1520 questions related to the trade/transaction execution risk category 524a, 386 of the answers to the questions were categorized (e.g., by the survey analysis engine 122 of FIG. 1) as exceptions 536a, 962 of the answers to the questions were categorized as best practices 536b, and 172 of the questions were categorized as “no data” 536c. In some implementations, questions may be categorized as sets according to rules (e.g., the rules data 152) such that the categorization of answers to certain questions may be linked together. Thus, survey questions and corresponding risk factors do not always have a one-to-one correlation, according to certain embodiments. The bar graph is arranged along a 0 to 100% x-axis, such that the reviewer may visually estimate relative percentages from risk category to risk category 524 in addition to reviewing raw numbers.

The screen shot 520 further presents a table 526 of top ten strategies ranked by percentage exceptions in the strategy risk categories 524. In an interactive portfolio-level report presented to a representative of the client via a browser or web portal interface, the individual strategies listed in a strategy column 528 may be user-selectable to obtain greater level of detail regarding exceptions discovered during analysis of each strategy. Further, the presentation of the strategies 528 may be rearrangeable, in an interactive report format, to organize, in some examples, by best-to-worst strategies ranked by strategy level exceptions 530, by percentage best practice 532, or by percentage no data 534.

Additionally, in some implementations, the screen shot 520 may include comments provided by an evaluator 108 of FIG. 1 guiding analysis of the information presented in the screen shot 520. The comments, in some examples, may relate to ancillary information or subject matter expertise that is not available within the structured question and answer selection model of the automated survey.

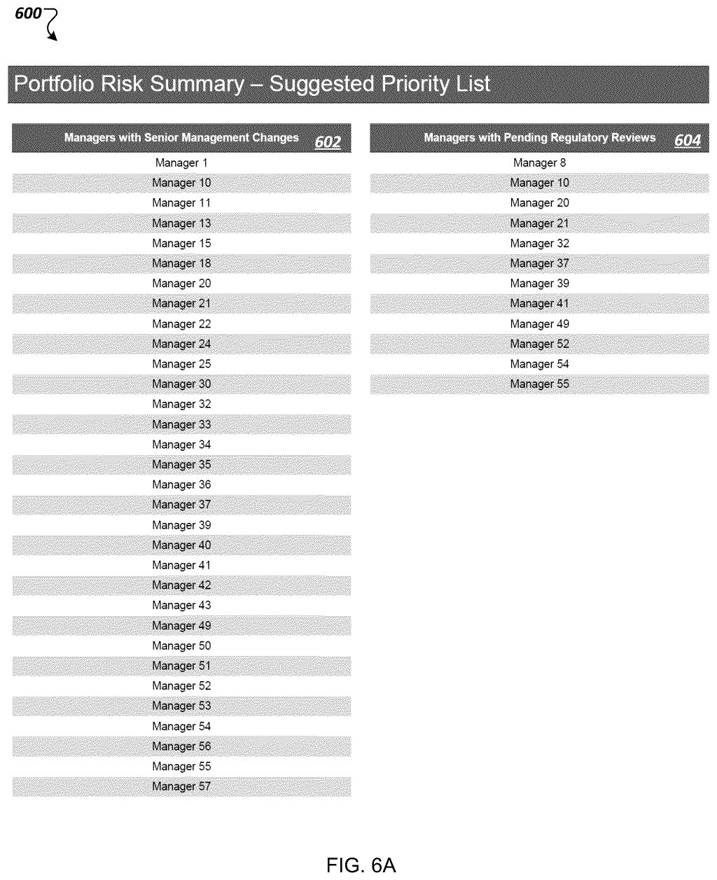

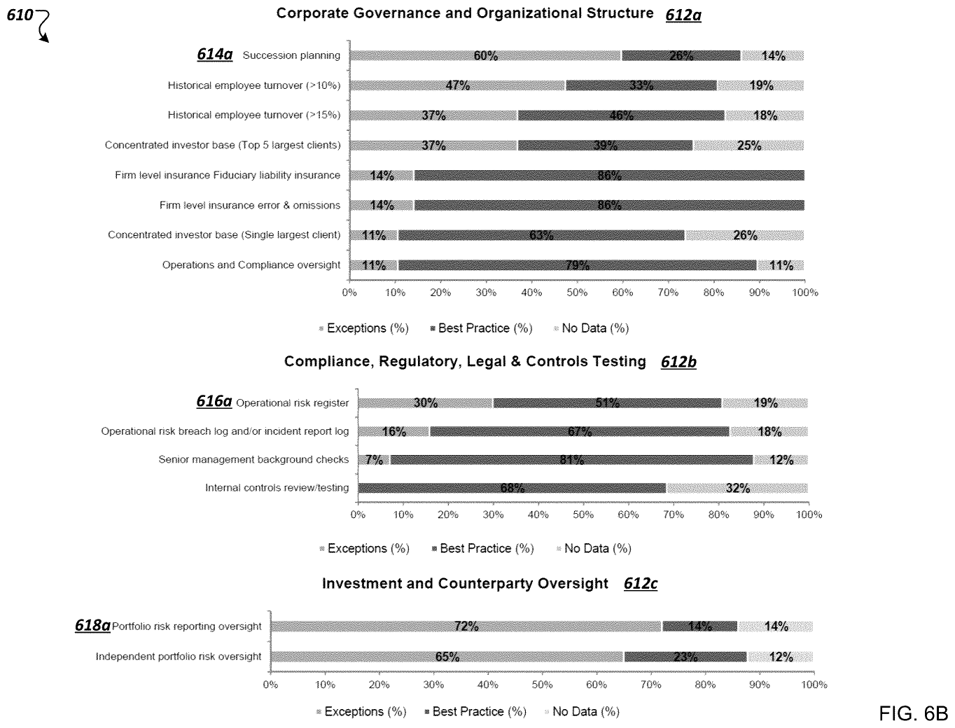

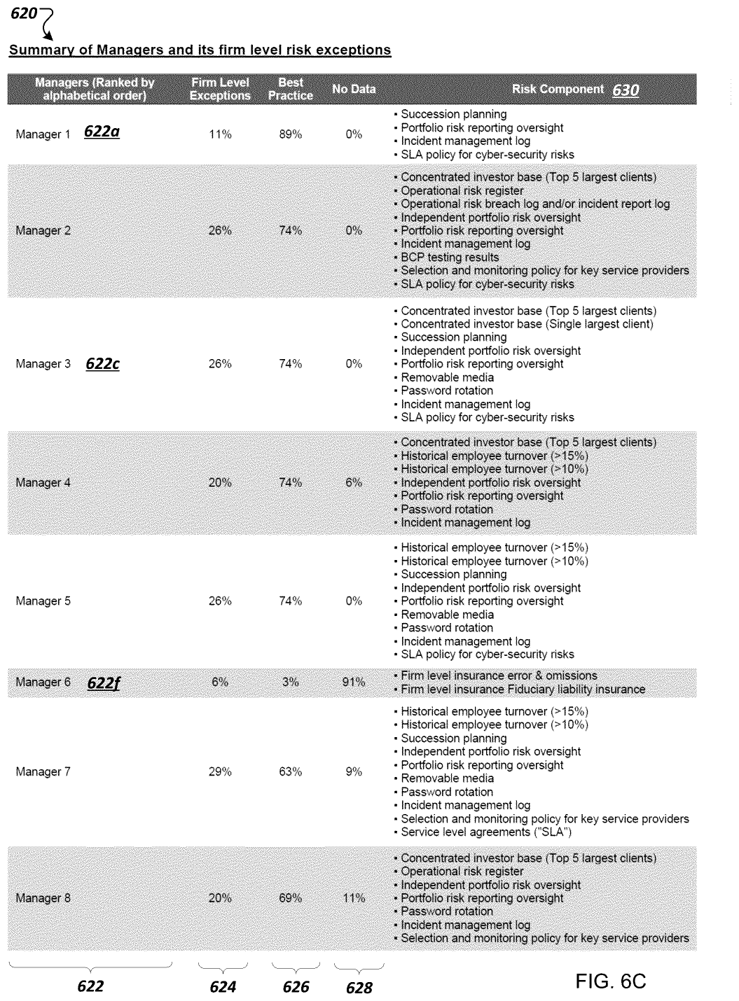

FIGS. 6A-6C further delve into firm-level risk assessments of the managers 602. The screen shots of FIGS. 6A-6C, in some implementations, are accessible through a web portal, for example by selecting portions of the portfolio risk summary-firm level screen shot 400 of FIG. 4A. Turning to FIG. 6A, a screen shot of a portfolio risk summary listing 600 presents a “suggested priority list” of managers 302 with senior management changes 602 and a “suggested priority list” of managers 302 with pending regulatory reviews 604. These examples may be part of a detailed breakdown of the top five common firm level risks with exceptions in the highest quartile 408, as illustrated in FIG. 4A. The managers 302 presented in the senior management changes priority list 602 and the pending regulatory review priority list 604, in some embodiments, are arranged in order of overall deviance from best practices (e.g., greatest number or greatest percentage of exceptions). In other examples, the managers 302 may be arranged in alphabetical order, in order of relevance to the portfolio under review (e.g., in percentage of holdings in the client's portfolio), or in order of greatest number or greatest percentage of exceptions in the firm risk categories categorized as being in the lowest quartile (e.g., uncommon among the larger grouping of managers). In an interactive browser-based or web portal report format, the managers may be re-prioritized or filtered according to the desires of the reviewing client.

As shown in FIG. 6B, certain firm risk categories presented in the graph 422 of FIG. 4B are further broken out into particular risk factors in a screen shot 610 of firm risk factor exception prevalence among the managers 302. The screen shot 610 only presents three of the risk categories (aspects) presented in graph 422 in FIG. 4B. The screen shot 610, for example, may contain a portion of the information (e.g., a first page of multiple pages).

The screen shot includes a corporate governance and organization structure risk category graph 612a, a compliance, regulatory, legal & controls testing risk category graph 612b, and an investment and counter party oversight risk category graph 612c. Each risk category graph 612 includes a number of risk factors, each risk factor presented as a bar of a bar chart having an x-axis of 0 to 100%. Each bar represents the managers' answers related to the particular risk factor categorized as exception, best practice, or no data. For example, a “succession planning” risk factor bar 614a illustrates that 60% of managers' answers corresponded to an exception from best practice, 26% of managers' answers corresponded to meeting the best practice, and 14% of managers did not provide answers related to succession planning. In some implementations, questions may be categorized as sets according to rules (e.g., the rules data 152 of FIG. 1) such that the categorization of answers to certain questions may be linked together. Thus, survey questions and corresponding risk factors do not always have a one-to-one correlation, according to certain embodiments.

FIG. 6C illustrates a screen shot 620 of a summary of managers and its firm level risk exceptions on a manager-by-manager basis. As illustrated, a first eight managers of the fifty-seven managers 302 (see FIG. 3A) are presented. The screen shot 620, for example, may present a first page of the overall portfolio report. For each manager in a manager column 622, a percentage of firm level exceptions 624, a percentage of best practices 626, and a percentage of no data 628 is listed. Further, a risk component column 630 provides a listing of factors corresponding to the percentage of firm level exceptions 624.

As illustrated in FIG. 6C, manager 1 622a demonstrates the highest percentage of best practices 626a (89%) in the screen shot 620, while manager 6 622f demonstrates the lowest percentage (3%) of best practices 626f. However, manager 6 622f also demonstrates the largest percentage of no data 628 at 91%. This suggests that manager 6 622f has not yet had an opportunity to provide full survey responses or the survey responses for manager 6 622f are outdated. In some implementations, a portion of the risk factors may be derived from information known by the operational assessment platform 102 or gathered automatically by the operational assessment platform 102 from external resources (e.g., such as regulatory compliance information). For example, the manager data 142 may contain information regarding each manager based upon a relationship between the manager 106 and the operational assessment platform 102. In an illustrative embodiment, the operational assessment platform 102 may be provided by an organization operating an insurance exchange platform. Thus, the organization would be aware of the risk factors (components) 630 illustrated in grid 630f corresponding to manager 6 622f related to firm level insurance error & omissions as well as firm level insurance fiduciary liability insurance. In another illustrative example, the organization may derive that manager 3 622c has a concentrated investor base (top 5 largest clients) based on information obtained from one or more of the financial services organizations 110 of FIG. 1. Thus, although described in relation to survey data 144 obtained from each of the managers 302 (e.g., a portion of the managers 106 of FIG. 1), in some embodiments, a portion of the risk factors can be derived from alternate sources.

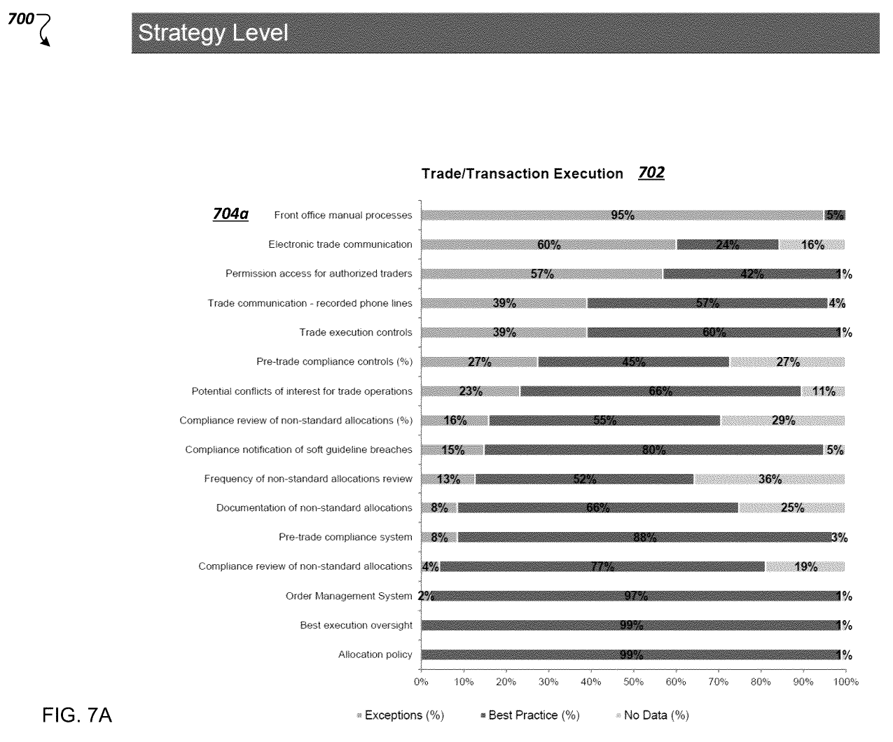

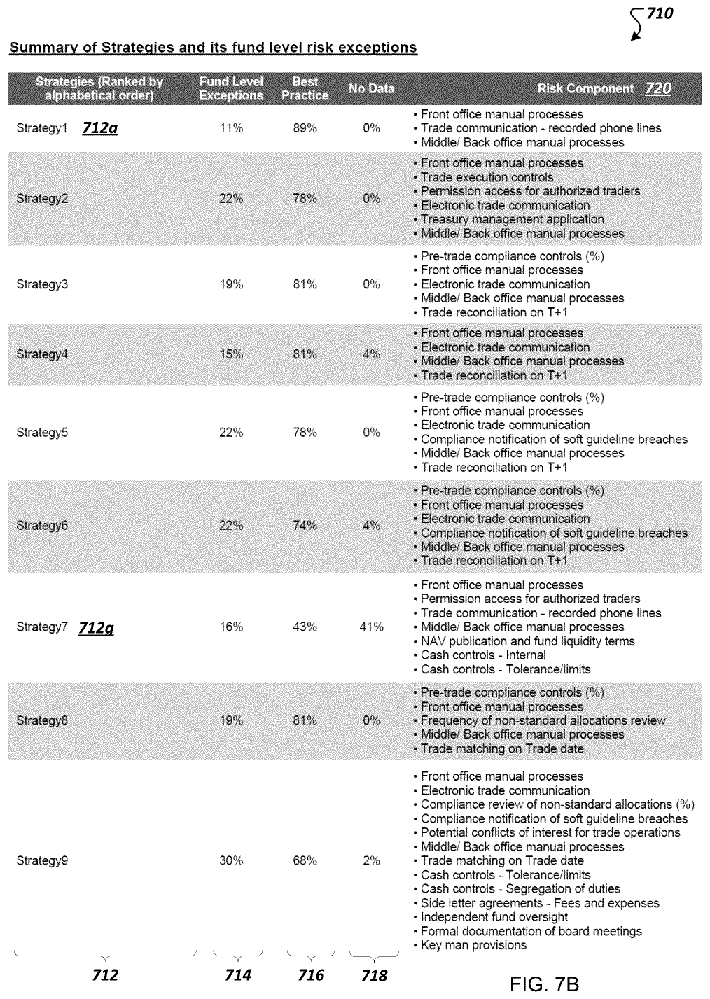

Similar to FIG. 6B, in FIG. 7A, a screen shot 700 illustrates an example strategy level risk category graph 702, presenting the trade/transaction execution strategy risk category (aspect). In some implementations, the strategy level risk category graph 702 is presented in response to selection of the trade/transaction execution bar 524a of the strategy risk categories graph 522 of FIG. 5B. Alternatively, the screen shot 700 may contain a portion of the information (e.g., a first page of multiple pages) illustrating all strategy level risk categories presented in the portfolio report.

In the strategy level risk category graph 702, risk factors of the trade/transaction execution strategy risk category are each presented as a bar of a bar chart having an x-axis of 0 to 100%. Each bar represents the managers' answers related to the particular risk factor categorized as exception, best practice, or no data. For example, a “front office manual processes” risk factor bar 704a illustrates that 95% of managers' answers corresponded to an exception from best practice, and 5% of managers' answers corresponded to meeting the best practice. Unlike the remaining bars of the strategy level risk category graph 702, the “front office manual processes” risk factor bar 704a lacks a “no data” responses section, meaning that all managers answered the question(s) rated to front office manual processes. As discussed previously, in some implementations, questions may be categorized as sets according to rules (e.g., the rules data 152 of FIG. 1) such that the categorization of answers to certain questions may be linked together. Thus, survey questions and corresponding risk factors do not always have a one-to-one correlation, according to certain embodiments.

Similar to FIG. 6C, a screen shot 710 of FIG. 7B illustrates a summary of strategies and its fund level risk exceptions for a first nine strategies of the ninety-five strategies 304 (see FIG. 3A). The screen shot 710 may contain a portion of the information (e.g., a first page of multiple pages) illustrating all strategies 304 presented in the portfolio report.

For each strategy in a strategy column 712, a percentage of fund level exceptions 714, a percentage of best practices 716, and a percentage of no data 718 is listed. Further, a risk component column 720 provides a listing of factors corresponding to the percentage of strategy level exceptions 714.

As illustrated in FIG. 7B, strategy1 712a demonstrates the highest percentage of best practices 626a (89%) in the screen shot 710, while strategy7 712g demonstrates the lowest percentage (43%) of best practices 716g. However, strategy7 712g also demonstrates the largest percentage of no data 718 at 41%. This suggests that one or more managers 302 answering questions related to strategy7 712g have not yet had an opportunity to provide full survey responses or the survey responses for one or more of the managers 302 are outdated (e.g., over one year old, at least 18 months old, at least two years old, at least three years old, etc.). For example, manager 6 622f of FIG. 6C answered nearly no (or, potentially absolutely no as discussed in relation to FIG. 6C) questions (e.g., 91% no data). If manager 6 corresponds to strategy7, it would make sense that, perhaps, one other manager also implementing strategy7 would have answered questions, while manager 6 failed to answer questions.

In some implementations, turning to FIG. 4D, firm assessment results, including results presented in various screen shots discussed above, may include data comparisons between the subject firm and peer firms. This analysis, for example, may be conducted in a similar manner to the formulation of comparisons to peer managers. As illustrated in an example peer comparison screen shot 460, peer firms may be identified based upon firm size 462 (e.g., large, mid-sized, small, or micro, etc.) and/or a number of managers 464. In further examples, peer firms may be identified by industry, geographic region, and/or maturity. As illustrated, the universe of firms is considered in the comparison, broken down by firm size 462 and further labeled by number of managers 464. For each firm risk category 466, a corresponding general assessment (e.g., above, average, or below, as illustrated) of the category performance is presented in relation to each firm size 462. Additionally, an overall assessment 468 of firm risk performance is presented in relation to each firm size 462. The overall assessments 468, for example, may represent an averaged assessment, a weighted average assessment, or other combination of the peer comparisons of the firm risk categories 466 to the corresponding firm size 462, Above the data comparisons, FIG. 4D includes a bar graph 470 identifying a number of peer firms in each firm size 462 category. The sizes, as identified to the left of the bar graph 470, are divided in the example into four classifications: micro (up to 25 employees), small (26-150 employees), mid (151-750 employees), and large (751 or more employees). In other embodiments, more or fewer classifications may be used, or the classifications may be divided into different ranges.

Returning to FIG. 1, in some implementations, rather than presenting reports containing analysis supplied by the survey analysis engine 122, the benchmark analysis engine 124, and the trend assessment engine 130, an evaluation data sharing engine 136 may provide portions of survey data 144, risk data 148, trend metrics 150, risk metrics 154, and/or evaluation data 156 for use by external parties in combining the various data and metrics with other data and metrics. For example, financial services organizations may log into the operational assessment platform 102 via a financial services organization engine 134 to obtain a set of data for inclusion in performance evaluations of various investment vehicles. In another example, the regulators and/or auditors 114 may log into the operational assessment platform 102 to access data formatted for audit processing. Further to the example, in the event that an industry standard for operational due diligence surveys is one day created, standardized data results may be supplied to regulators and/or auditors 114 via the regulators/auditors engine 137. In other embodiments, the regulators and/or auditors engine 137 may include generating a report (e.g., document-based or online-based) formatted for a regulator or auditor audience.

In some implementations, the evaluation data sharing engine 136 provides reports and/or portions of survey data 144, risk data 148, trend metrics 150, risk metrics 154, and/or evaluation data 156 to underwriters to support insurance underwriting on behalf of the managers 106 and/or to other entities or internal reviewers (e.g., supervisors, developers, and/or managers of the platform 102). For example, a risk underwriter may be provided information obtained and/or generated by the operational assessment platform 102 for use in increasing the efficiency and confidence in insurance underwriting. In another example, a platform sponsor of the operational assessment platform 102 may access metrics generated and compiled by the operational assessment platform to efficiently assess the range of outcomes among the investment products reviewed by the platform 102.

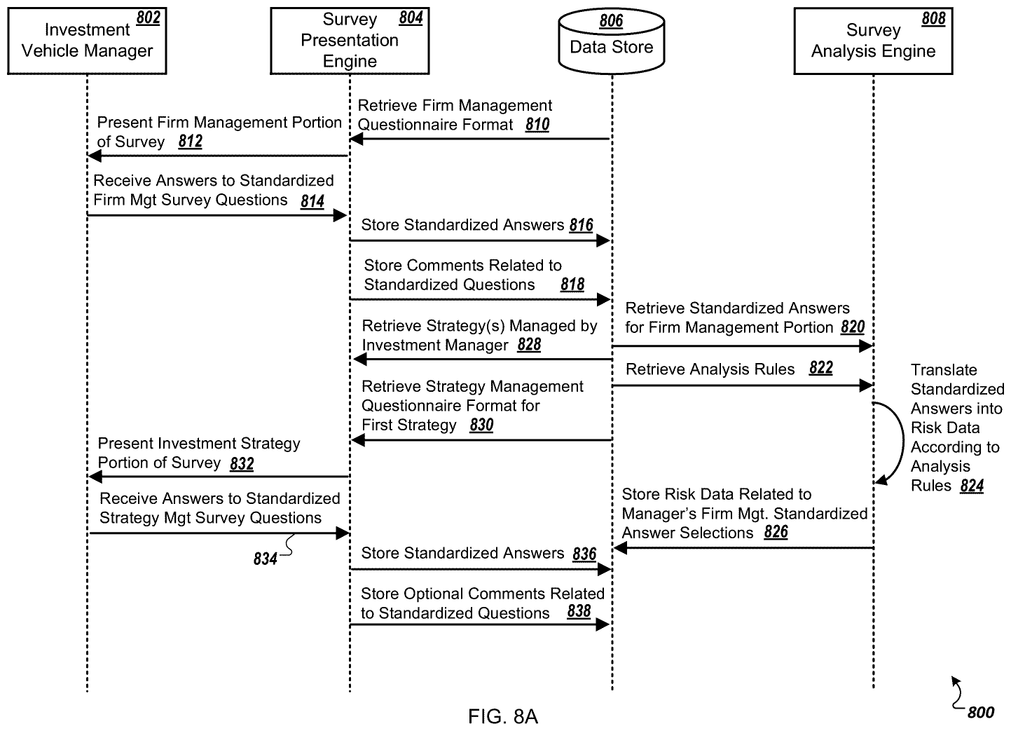

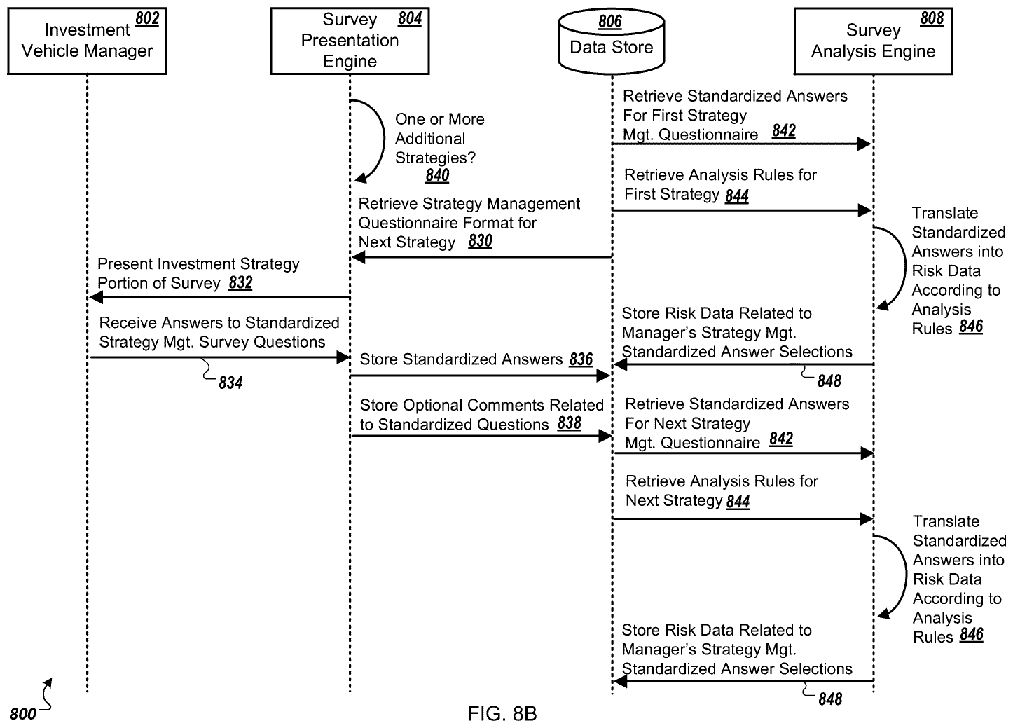

FIGS. 8A and 8B are a swim lane diagram of an example process 800 for obtaining and analyzing survey answers presented by a survey presentation engine 804 to an investment vehicle manager 802. The answers, for example, may be collected in a data store 806 and analyzed by a survey analysis engine 808. The process 800 may be performed by the operational assessment platform 102. For example, the survey presentation engine 120 may supply the survey questions to one or more managers 106 and store the answers as survey data 144 in the data repository 112. The survey analysis engine 122 of FIG. 1 may access the survey data 144 and convert the answers to risk data 148, also stored in the data repository 112.

In some implementations, the process 800 begins with retrieving (810), by the survey presentation engine 804, a firm management questionnaire format 810 from the data store 806. The firm management questionnaire format 810, for example, may include an electronic document format including selectable answers, such as an Excel document. In another example, the firm management questionnaire format 810 may include formatting files, such as style sheets (e.g., CSS), web mark-up language documents (e.g., XML, HTML, etc.), and content files for creating an interactive online survey for presentation to the manager 802. The particular firm management questionnaire format retrieved, in some embodiments, depends in part on the type of manager 802 and/or the type of survey desired. For example, various levels of survey (e.g., a full survey presented on a first schedule vs. a partial but more frequently scheduled survey) may be available for presentation to the manager 802. Further, retrieving the questionnaire format may include retrieving a number formatting documents, each directed to a separate questionnaire sections. In some examples, the sections may include a firm information section and a number of risk aspect sections.

In some implementations, the survey presentation engine 804 presents (812) the firm management portion of the survey to the manager 802 using the firm management questionnaire format. The survey presentation engine 120 of FIG. 1, for example, may present the firm management portion of the survey to one of the managers 106. In some embodiments, presenting the firm management portion of the survey includes emailing an electronic fillable document to the manager 802. In other embodiments, presenting the firm management portion of the survey includes presenting, through an online portal or web browser, an online fillable survey. In the circumstance of an online fillable survey, portions of the questionnaire format may be presented based upon information supplied by the manager 802 in response to initial questions, such as questions regarding the manager's firm size, maturity, geographic location, or information technology structure. The questions presented by the survey presentation engine 804 may relate to a number of firm management risk aspects such as, in some examples, firm governance, technology and cyber security, vendor management, trade settlement, and/or back office functions.

In some implementations, the questions presented are standardized questions presented to a group of managers, and the answers include standardized user-selectable answers. The standardized answers, in some examples, may include yes/no selections, single selection from a set number of options (e.g., via a drop-down menu or list), multiple selection from a set number of options (e.g., via a list), and/or numeric entry.

Further, in some implementations, at least a portion of the questions presented include, in addition to standardized answer options, a data entry field (e.g., text field) for supplying a customized response, such as a detailed explanation regarding a selected answer.

In some implementations, the survey presentation engine 804 receives (814) answers to standardized firm management survey questions from the manager 802. Further, if the manager 802 was provided the opportunity to enter a text comment related to some of the questions, the survey presentation engine 804 may receive custom information related to one or more survey questions. In the circumstance of a user-fillable electronic document, receiving the answers may include receiving a completed version of the electronic document. Conversely, in the circumstance of an online interactive survey, receiving the answers may include receiving submission of at least a portion of the survey. For example, the manager 802 may fill in portions of the survey, submitting the answers to the survey presentation engine 804 in a piecemeal fashion until the manager 802 indicates completion of the survey. Completion, in some embodiments, includes a number of unanswered questions. For example, the manager 802 may elect to leave a portion of the questions blank.

In some implementations, the survey presentation engine 804 stores (816) the standardized answers in the data store 806. The standardized answers, for example, may be stored in a database format for later retrieval. The standardized answers may be linked to the survey questions, such that, as standardized survey questions change (e.g., increase in number, alter in wording, etc.) comparisons are made between responses and the appropriate set of standardized survey questions maintained in the data store 806. In some embodiments, the standardized answers are timestamped for comparison with other standardized answers submitted by the manager 802 at a different time. For example, the standardized answers may be stored as survey data 144 in the data repository 112 of FIG. 1.

In some implementations, the survey presentation engine 804 stores (818) comments related to one or more standardized questions in the data store 806. Comments may be submitted, on a question-by-question basis, either in addition to or in lieu of selection of a standardized answer. For example, for one or more questions that the manager 802 felt were not adequately addressed by one of the standardized answers, the manager 802 may instead opt to submit a comment related to the standardized question. Any comments may be stored in the data store 806 keyed to the standardized question and/or the corresponding standardized answer. For example, the comments may be stored as survey data 144 in the data repository 112 of FIG. 1.

In some implementations, at some point in the future, the survey analysis engine 808 retrieves (820) the standardized answers for the firm management portion from the data store 806. The survey analysis engine 808, for example, may retrieve standardized answers related to the entire firm management questionnaire or to one or more portions (e.g., risk aspects) of the questionnaire presented to the manager 802. The survey analysis engine 808, for example, may be configured to access and analyze questions on a periodic basis, regardless of whether the manager 802 has completed the entire questionnaire, as long as a portion of finalized answers has been submitted. In other embodiments, the survey analysis engine 808 may be configured to retrieve the standardized answers based on a trigger (e.g., indication of completion of the survey by the manager 802, receipt of a request for a manager report or portfolio report involving the manager 802, etc.). For example, the survey analysis engine 122 may retrieve the survey data 144 from the data repository 112 of FIG. 1.

The survey analysis engine 808, in some implementations, retrieves (822) analysis rules from the data store 806. The analysis rules may include various analysis factors in identifying risk exceptions within the standardized answers provided by the manager 802. The analysis rules, in some embodiments, differ based upon characteristics of the investment manager 802. For example, best practice expectations for a large mature firm may differ from best practice expectations for a young, small firm. Further, best practice expectations may differ based upon investment strategies offered by the manager 802. Hedge fund managers, for example, may have different legal requirements and expectations than real estate fund investment managers. Although described as one set of analysis rules, the analysis rules may be separated into the various risk aspects covered within the firm management questionnaire. For example, the survey analysis engine 808 may access separate analysis rules for each risk aspect being analyzed (e.g., firm governance, technology and cyber security, vendor management, trade settlement, and/or back office functions, etc.). In some embodiments, the survey analysis engine 122 may retrieve the rules data 152 from the data repository 112 of FIG. 1.

In some implementations, the survey analysis engine 808 translates (824) the standardized answers into risk data according to the analysis rules. As discussed above, the standardized answers may be categorized as exceptions to best practices or as best practices in accordance to the analysis rules. The analysis rules may include, in some examples, binary factors (e.g., answer “no” to question #3 is indicative of a risk exception), range factors (e.g., if the numeric value of the answer to question #56 is less than 5, this is indicative of a risk exception), and/or combination factors (e.g., if the answer to question #41 is “no” and the answer to question #5 is greater than 1,000 it is indicative of a risk exception). Thus, the risk data may include fewer independent values than the number of standardized answers analyzed. Although described as being a binary decision (e.g., best practice or exception from best practice), in other embodiments, the survey analysis engine 808 may classify the standardized answers into three or more categories, such as best practice, exception to best practice, and exception to required practice (e.g., in the event that one or more best practices are requirements placed by legal or certification bodies, etc.). Additionally, if one or more questions were left unanswered or answered only using a comment option, the survey analysis engine 808 may enter a “no data available” value for those questions into the risk data. In an illustrative example, the survey analysis engine 122 or FIG. 1 translates the survey data 144 into the risk data 148.

In some implementations, the survey analysis engine 808 stores (826) the risk data in the data store 806. The risk data, for example, may be stored in a database format for later retrieval. The risk data may be linked to the survey questions, such that, as standardized survey questions change (e.g., increase in number, alter in wording, etc.) comparisons are made between responses and the appropriate set (version) of standardized survey questions maintained in the data store 806. In some embodiments, the risk data are timestamped. For example, the risk data may be stored as risk data 148 in the data repository 112 of FIG. 1.

Returning to obtaining information from the manager 802, in some implementations, the survey presentation engine 804 retrieves (828) one or more strategies managed by the investment vehicle manager 802 from the data store 806. The one or more strategies, for example, may be identified within the standardized answers collected by the survey presentation engine 804 via the firm management questionnaire or another initial questionnaire (e.g., firm information questionnaire). In another example, the one or more strategies may be retrieved from the portfolios of one or more clients, such as a requesting client. Turning to FIG. 1, for example, the manager strategies may be identified in the portfolio data 138 maintained in the data repository 112. In a further example, the one or more strategies may be identified from manager data 142 maintained by the data repository 112 of FIG. 1. The manager data 142, for example, may be obtained from a third-party source, such as the financial services organizations 110, identifying strategies offered by various investment vehicle managers such as the managers 106 of FIG. 1.

Using the one or more strategies, in some implementations, the survey presentation engine 804 retrieves (830), from the data store 806, a strategy management questionnaire format for a first strategy of the one or more strategies. Similar to the firm management questionnaire format discussed above in relation to step 810, the strategy management questionnaire format may include an electronic document format including selectable answers or formatting files and content files for creating an interactive online survey for presentation to the manager 802. The strategy management questionnaire format retrieved, in some embodiments, depends in part on the type of manager 802 and/or the type of survey desired. For example, various levels of strategy survey (e.g., a full survey presented on a first schedule vs. a partial but more frequently scheduled survey) may be available for presentation to the manager 802. Further, retrieving the questionnaire format may include retrieving a number formatting documents, each directed to a separate questionnaire section. The sections may include a number of risk aspect sections.

In some implementations, the survey presentation engine 804 presents (832) the first strategy management portion of the survey to the manager 802 using the strategy management questionnaire format. The survey presentation engine 120 of FIG. 1, for example, may present the first strategy management portion of the survey to one of the managers 106. In some embodiments, presenting the strategy management portion of the survey includes emailing an electronic fillable document to the manager 802. In other embodiments, presenting the strategy management portion of the survey includes presenting, through an online portal or web browser, an online fillable survey. In the circumstance of an online fillable survey, portions of the questionnaire format may be presented based upon information supplied by the manager 802 in response to initial questions. The questions presented by the survey presentation engine 804 may relate to a number of strategy management risk aspects such as, in some examples, a trade/transaction execution category, a middle-back office, valuation, and cash controls category, and/or a fund governance, structure, and administration category. Different strategies may be represented by different risk categories or risk aspects. For example, a real estate strategy may consider risks related to third party property managers, while a hedge fund strategy may consider risks related to prime broker financing.

In some implementations, the questions presented are standardized questions presented to a group of managers, and the answers include standardized user-selectable answers. The standardized answers, in some examples, may include yes/no selections, single selection from a set number of options (e.g., via a drop-down menu or list), multiple selection from a set number of options (e.g., via a list), and/or numeric entry. Further, in some implementations, at least a portion of the questions presented include, in addition to standardized answer options, a data entry field (e.g., text field) for supplying a customized response, such as a detailed explanation regarding a selected answer.

In some implementations, the survey presentation engine 804 receives (834) answers to standardized strategy management survey questions from the manager 802. Further, if the manager 802 was provided the opportunity to enter a text comment related to some of the questions, the survey presentation engine 804 may receive custom information related to one or more survey questions. In the circumstance of a user-fillable electronic document, receiving the answers may include receiving a completed version of the electronic document. Conversely, in the circumstance of an online interactive survey, receiving the answers may include receiving submission of at least a portion of the survey. For example, the manager 802 may fill in portions of the survey, submitting the answers to the survey presentation engine 804 in a piecemeal fashion until the manager 802 indicates completion of the survey. Completion, in some embodiments, includes a number of unanswered questions. For example, the manager 802 may elect to leave a portion of the questions blank.

In some implementations, the survey presentation engine 804 stores (836) the standardized answers in the data store 806. The standardized answers, for example, may be stored in a database format for later retrieval. The standardized answers may be linked to the survey questions, such that, as standardized survey questions change (e.g., increase in number, alter in wording, etc.) comparisons are made between responses and the appropriate set of standardized survey questions maintained in the data store 806. In some embodiments, the standardized answers are timestamped for comparison with other standardized answers submitted by the manager 802 at a different time. For example, the standardized answers may be stored as survey data 144 in the data repository 112 of FIG. 1.

In some implementations, the survey presentation engine 804 stores (838) comments related to one or more standardized questions in the data store 806. Comments may be submitted, on a question-by-question basis, either in addition to or in lieu of selection of a standardized answer. For example, for one or more questions that the manager 802 felt were not adequately addressed by one of the standardized answers, the manager 802 may instead opt to submit a comment related to the standardized question. Any comments may be stored in the data store 806 keyed to the standardized question and/or the corresponding standardized answer. For example, the comments may be stored as survey data 144 in the data repository 112 of FIG. 1.

Turning to FIG. 8B, if additional strategies were retrieved at step 828 (840), in some implementations, steps 830, 832, 834, 836, and 838 are repeated for each strategy. Conversely, for example, in the circumstance of an emailed electronic document, all of the strategies, in other implementations, are combined into a single questionnaire for presentation (832), receipt (834), and storage (836, 838).

Meanwhile, at some point in the future, the survey analysis engine 808, in some implementations, retrieves (842) the standardized answers for the first strategy management portion from the data store 806. The survey analysis engine 808, for example, may retrieve standardized answers related to the entire strategy management questionnaire or to one or more portions (e.g., risk aspects) of the questionnaire presented to the manager 802. The survey analysis engine 808, for example, may be configured to access and analyze questions on a periodic basis, regardless of whether the manager 802 has completed the entire questionnaire, as long as a portion of finalized answers has been submitted. In other embodiments, the survey analysis engine 808 may be configured to retrieve the standardized answers based on a trigger (e.g., indication of completion of at least the first strategy management questionnaire of the strategy management survey by the manager 802, receipt of a request for a manager report or portfolio report involving the manager 802, etc.). For example, the survey analysis engine 122 may retrieve the survey data 144 from the data repository 112 of FIG. 1.

The survey analysis engine 808, in some implementations, retrieves (844) analysis rules from the data store 806. The analysis rules may include various analysis factors in identifying risk exceptions within the standardized answers provided by the manager 802. The analysis rules, in some embodiments, differ based upon characteristics of the investment manager 802. For example, best practice expectations for a large mature firm may differ from best practice expectations for a young, small firm. Further, best practice expectations may differ based upon investment strategies offered by the manager 802. Hedge fund managers, for example, may have different legal requirements and expectations than real estate fund investment managers. Although described as one set of analysis rules, the analysis rules may be separated into the various risk aspects covered within the strategy management questionnaire. For example, the survey analysis engine 808 may access separate analysis rules for each risk aspect being analyzed (e.g., a trade/transaction execution aspect, a middle-back office, valuation, and cash controls aspect, and/or a fund governance, structure, and administration aspect, etc.). In some embodiments, the survey analysis engine 122 may retrieve the rules data 152 from the data repository 112 of FIG. 1.

In some implementations, the survey analysis engine 808 translates (846) the standardized answers into risk data according to the analysis rules. As discussed above, the standardized answers may be categorized as exceptions to best practices or as best practices in accordance to the analysis rules. The analysis rules may include, in some examples, binary factors (e.g., answer “no” to question #3 is indicative of a risk exception), range factors (e.g., if the numeric value of the answer to question #56 is less than 5, this is indicative of a risk exception), and/or combination factors (e.g., if the answer to question #41 is “no” and the answer to question #5 is greater than 1,000 it is indicative of a risk exception). Thus, the risk data may include fewer independent values than the number of standardized answers analyzed. Although described as being a binary decision (e.g., best practice or exception from best practice), in other embodiments, the survey analysis engine 808 may classify the standardized answers into three or more categories, such as best practice, exception to best practice, and exception to required practice (e.g., in the event that one or more best practices are requirements placed by legal or certification bodies, etc.). Additionally, if one or more questions were left unanswered or answered only using a comment option, the survey analysis engine 808 may enter a “no data available” value for those questions into the risk data. In an illustrative example, the survey analysis engine 122 or FIG. 1 translates the survey data 144 into the risk data 148.

In some implementations, the survey analysis engine 808 stores (848) the risk data in the data store 806. The risk data, for example, may be stored in a database format for later retrieval. The risk data may be linked to the survey questions, such that, as standardized survey questions change (e.g., increase in number, alter in wording, etc.) comparisons are made between responses and the appropriate set of standardized survey questions maintained in the data store 806. In some embodiments, the risk data are timestamped. For example, the risk data may be stored as risk data 148 in the data repository 112 of FIG. 1.

If additional strategies were retrieved at step 828 (840), in some implementations, steps 842, 844, 846, and 848 are repeated for each strategy. Conversely, multiple (or all) of the strategies and corresponding analysis rules, in other implementations, may be retrieved (842, 844) at once by the survey analysis engine 808 for translation according to analysis rules (846) and storage as risk data (848).

Despite being illustrated as a particular flow of operations, in other implementations, more or fewer operations may exist. Additionally, some operations may be performed in a different order than illustrated in FIGS. 8A and 8B.

Although illustrated as the single data store 808, in other implementations, the data store 808 may include a number of data storage regions or devices, including local, remote, and/or cloud storage on various types of storage devices. For example, the questionnaire format(s) may be maintained separately from a database including the standardized answers received from the manager 802. Further, some information may be relocated. In illustration, standardized answers may be initially stored in a fast access memory region, then transferred to a long-term storage region at a later time.

While the survey analysis engine 808 is illustrated as analyzing (824) the standardized answers after the standardized questions have all been answered by the investment vehicle manager 802, in other embodiments, the survey analysis engine 808 may retrieve answers once submitted in relation to any firm management risk aspect, regardless of the manager's progress related to other portions of the firm management questionnaire.

Other modifications to the process 800 may be made while remaining with the scope and spirit of the disclosure.

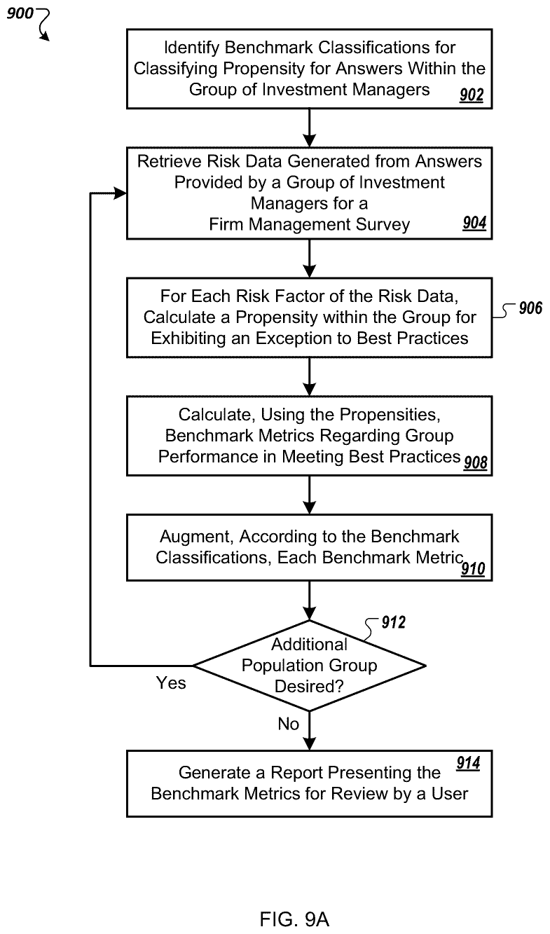

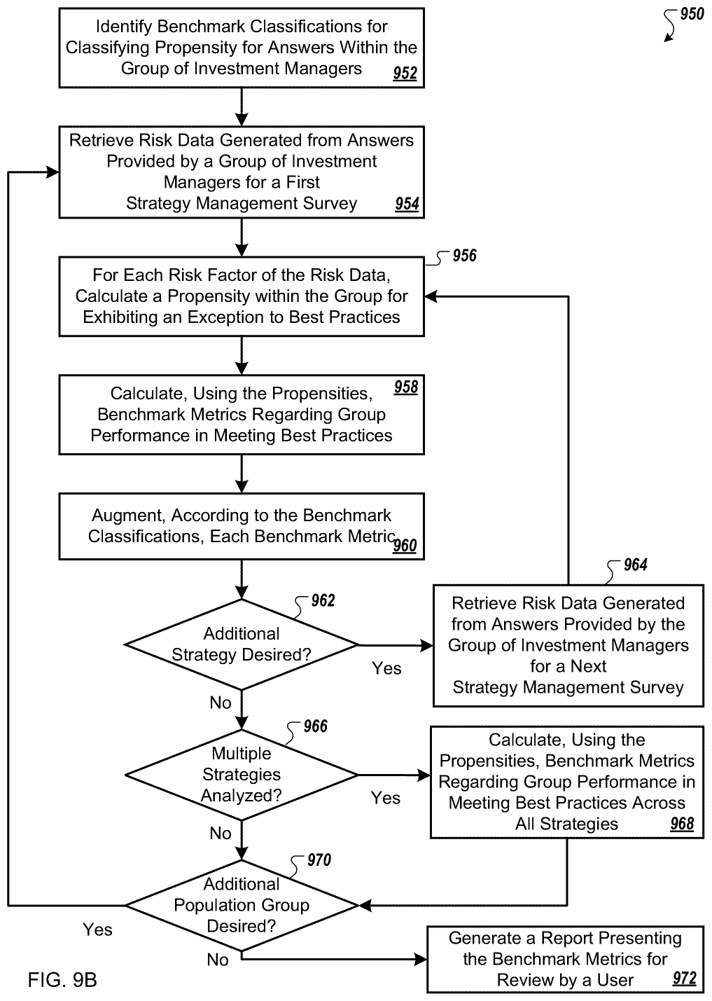

FIGS. 9A and 9B are flow charts of example methods for benchmarking one or more groups of investment vehicle managers using risk data derived from standardized survey answers. The groups, in some examples, can include all managers for which data is available (e.g., “the universe”), managers of investment vehicles held within the portfolio of a requesting client, or managers sharing one or more characteristics with the manager under evaluation (e.g., peers of the manager). The methods, for example, may be performed by one or more engines of the operational assessment platform 102 of FIG. 2 to derive benchmark metrics related to standardized ODD assessments performed on the managers 106. The standardized ODD assessments, for example, may be collected and automatically analyzed using the process 800 described in relation to FIGS. 8A and 8B. The methods described in relation to FIGS. 9A and 9B can be applied, in some examples, in assessing performance of an individual manager (e.g., a “manager report” for review by one of the managers 106 of FIG. 1), in assessing performance of managers within a portfolio (e.g., a “portfolio report” for review by one of the clients 104 of FIG. 1), or in assessing performance of a population of managers on behalf of a third party (e.g., an “audit report” for review by one of the regulators/auditors 114). Further, portions of the methods of FIGS. 9A and 9B can be used to derive benchmark metrics regarding a population of managers for sharing with a third party (e.g., risk metrics 154 for sharing with one of the financial services organizations 110).

Turning to FIG. 9A, in some implementations, an example method 900 for benchmarking the risk data derived through an ODD assessment of firm management aspects performed on group of investment managers begins with identifying benchmark classifications for classifying propensity for answers within the group of investment managers (902). The benchmark classifications, for example, may guide presentation of benchmark metrics through qualifying the metrics value in some manner. The benchmark classifications, in some embodiments, identify a quantile classification to apply to the benchmark metrics in classifying whether a risk data value or benchmark metric represents a deviance or a similarity. A risk data value or benchmark metric corresponding to a risk aspect assessed in view of a particular manager of the group of investment managers may be presented in view of the aggregation of the same risk data value or benchmark metric derived from assessments of each manager of the group of managers to qualify behaviors of the particular manager in view of the group as a whole. Similarly, risk data values or benchmark metrics corresponding to a risk aspect assessed in view of each manager of the group of investment managers may be presented in view of the aggregation of the same risk data value or benchmark metric for all managers of the group of managers to qualify behaviors of segments of the group of managers in view of the group as a whole. Since the benchmark classifications assist in making comparisons of a particular manager's behaviors or subset of manager's behaviors in view of a population of investment managers, the qualified comparison is objective rather than subjective (e.g., the exception from best practice is not identified as “bad”, instead, it is identified as “relatively common” or “relatively uncommon”, etc.). The benchmark metrics, in this manner, not only support objective ODD assessments but also provide the opportunity to track current common practices within a group of investment managers which may deviate from a client's view or expert's view of what best practices should be. Thus, the benchmark classification may place the behaviors of a reviewed manager in an identified quantile in view of the group as a whole such as, in some examples, a tercile classification, a quartile classification, a decile classification, or a percentile classification. Further, the benchmark classification may separate the behaviors of the managers of the group into quantiles covering, in sum, all managers of the group having contributed a standardized answer or answer set related to the assessed risk factor.

The benchmark classifications, in some embodiments, are retrieved from a storage area. For example, the benchmark classifications may be associated with a particular report type (e.g., manager report, portfolio report, trend analysis report, etc.), a particular assessment type (e.g., strategy management risk assessment, firm management risk assessment, etc.), or a particular client. For example, one or more of the clients 104 may designate customized parameters for report generation in the operational assessment platform, for example stored as client data 146. In another example, the benchmark classification scheme may be a system default (e.g., the benchmark classifications 158). The benchmark classifications (e.g., client-specific classifications, report-specific classifications, or default benchmark classifications 158), for example, may be accessed by the benchmark analysis engine 124 of FIG. 1 from the data repository 112.

In other embodiments, the benchmark classifications are designated along with a report request. For example, upon submission of a request for a report, a user (e.g., client 104, regulator/auditor 114, etc.) may designate a particular benchmark classification scheme to use in the report.

In some implementations, risk data generated from answers provided by the group of investment managers for a firm management survey are retrieved (904). The risk data may represent a portion of firm management risk aspects or all firm management risk aspects, depending upon the desired output from the method 900. In retrieving the risk data, in some embodiments, the most recent risk data from multiple sets of firm data is retrieved for each investment manager of the group of investment managers. For example, the risk data 148 may be retrieved by the benchmark analysis engine 124 from the data repository 112 of FIG. 1.

The risk data for a particular investment manager of the group, in certain embodiments, may not be retrieved based upon a time stamp associated with the particular manager's risk data. For example, if the particular manager has not completed a firm management survey, at least in part, in the past threshold amount of time (e.g., one year, two years, etc.), any risk data retained in relation to the manager may be left out of the analysis performed by the method 900 as being stale.

For each risk factor of the risk data, in some implementations, a propensity within the group of investment managers for exhibiting an exception to best practice corresponding to the risk factor is calculated (906). As explained above, each risk factor corresponds to one or more questions presented to the managers of the group in a standardized questionnaire regarding the particular risk factor. Each risk factor may be categorized under a risk aspect (e.g., firm management aspect or category). In illustration, as shown in FIG. 6B, risk factors 614 are categorized under risk aspect 612a (corporate governance and organizational structure), risk factors 616 are categorized under risk aspect 612b (compliance, regulator, legal & controls testing), and risk factors 618 are categorized under risk aspect 612c (investment and counterparty oversight). A value corresponding to each risk factor (e.g., best practice or exception to best practice, etc.) relates to a particular answer selection of a set of standardized answers applied by the manager responsive to each of the one or more questions related to the particular risk factor. Thus, in calculating the propensity within the group of investment managers for exhibiting the exception to best practice, the number of managers associated with each potential risk value (e.g., best practice, exception to best practice, no data, etc.) may be tallied and compared to a number of managers in total. In illustration, turning to FIG. 6B, for each risk factor 614, 616, and 618, managers within a group are separated into a percentage exhibiting best practices, a percentage exhibiting exception to best practice, and a percentage having failed to select standardized answer(s) spanning a bar of a bar graph representing one hundred percent of the managers analyzed. In another example, FIG. 2B illustrates portfolio quartile analysis graphics 220a-c demonstrating exception propensity for three separate risk factors 214 within a manager group of a client portfolio as well as universe quartile analysis graphics 222a-c demonstrating exception propensity for three separate risk factors 214 within all managers of the system (e.g., the managers 106 of the operational assessment platform 102). The benchmark analysis engine 124 of FIG. 1, for example, may calculate the risk factor propensities as risk metrics 154.

In some implementations, benchmark metrics regarding performance of the group of investment managers in meeting best practices are calculated using the propensities (908). The benchmark analysis engine 124 of FIG. 1, for example, may calculate the benchmark metrics as risk metrics 154.

The benchmark metrics, in some embodiments, include aggregation metrics combining all firm management risk factors within the population group. In illustration, FIG. 2A includes a quartile analysis key 206 and quartile analysis example graphics 208 illustrating color-coded quartile circle graphics breaking down risk factors corresponding to a particular manager 204a into quartile exceptions in comparison to a certain population of managers. The quartile analysis graphic 208a compares the risk factors of the manager 204a to the risk factor propensities of a group of managers of a reviewed portfolio. Similarly, the quartile analysis graphic 208b compares the risk factors of the manager 204a to the risk factor propensities of all of the managers (e.g., “the universe”).

The benchmark metrics, in some embodiments, include aggregation metrics combining all firm management risk factors within each firm management risk aspect for the population group. For example, FIG. 3A illustrates the bar graph 312 summarizing best practice, exception, and no data propensities within each firm management risk category 318 for the managers 302 within a reviewed portfolio.

In some embodiments, the benchmark metrics include aggregation metrics combining all firm management risk factors for each individual manager. For example, FIG. 4B illustrates a table summarizing percentages of exceptions 430, best practices 432, and no data 434 managers 428. The benchmark metrics, in further embodiments, include aggregation metrics combining all firm management risk factors within each firm management risk aspect for each individual manager.

In some implementations, each benchmark metric is augmented according to the benchmark classifications (910). The risk metrics, for example, may include visual augmentation identifiers for augmenting the benchmark metrics. In an example involving quartile graphic illustrations, as illustrated in FIG. 2A, a key 206 designates that the percent of exceptions above the 75^{th} percentile is color-coded green, the percent of exceptions between the 25^{th} and the 75^{th} percentile is color-coded yellow, and the percent of exceptions below the 25^{th} percentile is color-coded red. Other examples of visual augmentation include differing dash patterns within a line graph, differing fill patterns within a bar graph, or different color schemes. For example, as illustrated in FIG. 4B, a color scheme of orange, blue, and gray is used in the bar graph 422. Other augmentation schemes are possible.

In some implementations, for each population group of investment managers identified, steps 904, 906, 908, and 910 are repeated (912). The population groups as illustrated in FIG. 2A for example, can include the universe of managers, the managers of a particular client portfolio, and peer groups of managers.

In some implementations, a report is generated presenting the classified benchmark metrics for review by a user (914). Example excerpts from a firm management report are illustrated and described in relation to FIGS. 2A-2D, FIGS. 4A-4B, and FIGS. 6A-6C. The report, for example, may be generated by the manager report generation engine 126 and/or the portfolio report generation engine 132 of FIG. 1.

Although the method 900 is illustrated in FIG. 9A as having a particular flow of operations, in other implementations, more or fewer steps may exist. The steps of the method 900 may depend in part upon the end audience for the information. For example, rather than generating a report, the benchmark metrics may be supplied directly to a financial services organization for combining with the organization's internal data. The financial services organization engine 134 of FIG. 1, for example, may provide the risk metrics 154 to a financial services organization 110. Additionally, some steps of the method 900, in other embodiments may be performed in a different order than illustrated in FIG. 9A or in parallel. For example, the benchmark metrics may be augmented according to the benchmark classifications (910) during generation of the report (914). Other modifications to the method 900 are possible while remaining with the scope and spirit of the disclosure.

Similar to the method 900 illustrated in FIG. 9A, FIG. 9B presents an example method 950 for benchmarking the risk data derived through an ODD assessment of strategy management aspects of one or more investment strategies performed on a group of investment managers. The method 950 involves many of the same steps as the method 900 and may be performed before, after, or in parallel with the method 900.

In some implementations, the method 950 begins with identifying benchmark classifications for classifying propensity for answers within the group of investment managers (952). Benchmark classifications are discussed in detail above in relation to step 902 of FIG. 9A. The benchmark classifications, for example, may be the same as the benchmark classifications used in step 902 of the method 900. Conversely, in some embodiments, differing benchmark classifications may be used between the firm risk management (method 900) and the strategy risk management (method 950). However, while the benchmarked managers in the method 900 could, theoretically, involve all managers (e.g., “the universe”), in the method 950 only those managers providing the same investment strategy are qualified to be grouped together for direct comparison.

In some implementations, risk data generated from answers provided by the group of investment managers for a first strategy management survey are retrieved (954). The risk data may represent a portion of strategy management risk aspects or all strategy management risk aspects associated with the first strategy, depending upon the desired output from the method 950. In retrieving the risk data, in some embodiments, the most recent risk data from multiple sets of strategy data is retrieved for each investment manager of the group of investment managers. For example, the risk data 148 may be retrieved by the benchmark analysis engine 124 from the data repository 112 of FIG. 1.

The risk data for a particular investment manager of the group, in certain embodiments, may not be retrieved based upon a time stamp associated with the particular manager's risk data. For example, if the particular manager has not completed a strategy management survey related to the first strategy, at least in part, in the past threshold amount of time (e.g., one year, two years, etc.), any risk data retained in relation to the manager may be left out of the analysis performed by the method 950 as being stale.

For each risk factor of the risk data, in some implementations, a propensity within the group of investment managers for exhibiting an exception to best practice corresponding to the risk factor is calculated (956). As explained above, each risk factor corresponds to one or more questions presented to the managers of the group in a standardized questionnaire regarding the particular risk factor. Each risk factor may be categorized under a risk aspect (e.g., strategy management aspect or category). In illustration, as shown in FIG. 7A, risk factors 704 are categorized under risk aspect 702 (trade/transaction execution). A value corresponding to each risk factor (e.g., best practice or exception to best practice, etc.) relates to a particular answer selection of a set of standardized answers applied by the manager responsive to each of the one or more questions related to the particular risk factor. Thus, in calculating the propensity within the group of investment managers for exhibiting the exception to best practice, the number of managers associated with each potential risk value (e.g., best practice, exception to best practice, no data, etc.) may be tallied and compared to a number of managers in total. In illustration, turning to FIG. 7A, for each risk factor 704, managers within a group are separated into a percentage exhibiting best practices, a percentage exhibiting exception to best practice, and a percentage having failed to select standardized answer(s) spanning a bar of a bar graph representing one hundred percent of the managers analyzed.

In some implementations, benchmark metrics regarding performance of the group of investment managers in meeting best practices are calculated using the propensities (958). The benchmark analysis engine 124 of FIG. 1, for example, may calculate the benchmark metrics as risk metrics 154.

The benchmark metrics, in some embodiments, include aggregation metrics combining all strategy management risk factors of the first strategy within the population group. For example, FIG. 5B illustrates table 526 including aggregate propensities for exceptions 530, best practices 532, and no data 534 within each strategy 528.

The benchmark metrics, in some embodiments, include aggregation metrics combining all strategy management risk factors within each strategy management risk aspect for the population group. For example, FIG. 5B illustrates the bar graph 522 summarizing best practice, exception, and no data propensities within each strategy management risk category 524 for the managers within a reviewed portfolio.

In some embodiments, the benchmark metrics include aggregation metrics combining all strategy management risk factors for each individual manager in the population group.

In some implementations, each benchmark metric is augmented according to the benchmark classifications (960). The augmentation, for example, can be accomplished as described in relation to step 910 of FIG. 9A.

In some implementations, if analysis of an additional strategy is desired (962), the risk data generated from answers provided by the group of investment managers for a next strategy management survey is retrieved (964). Note that different managers will supply different strategies, either in general or in reference to the reviewed portfolio in the circumstance of a portfolio review. Thus, each time the steps 956, 958, and 960 are repeated, a different sub-population of an over-all target population (e.g., managers within the universe, managers within the portfolio, etc.) may be analyzed together.

In some implementations, after all desired strategies have been analyzed (962), if multiple strategies were analyzed (966), benchmark metrics regarding group performance in meeting best practices across all analyzed strategies are calculated (968). In illustration, FIG. 5A includes a color-coded quartile circle graphic 506 breaking down risk factors (risk areas) corresponding to managers of a client's portfolio into quartile exception propensities (e.g., most managers demonstrate the exception, some managers demonstrate the exception, and a minority of managers demonstrate the exception).

In some implementations, for each population group of investment managers identified, steps 954, 956, 958, 960, 962, 964, 966, and 968 are repeated (970). The population groups as illustrated in FIG. 2A for example, can include the universe of managers, the managers of a particular client portfolio, and peer groups of managers.

In some implementations, a report is generated presenting the classified benchmark metrics for review by a user (972). Example excerpts from a strategy management report are illustrated and described in relation to FIG. 2A, FIGS. 3A-3B, FIGS. 5A-5B, and FIGS. 7A-7B. The report, for example, may be generated by the manager report generation engine 126 and/or the portfolio report generation engine 132 of FIG. 1.

Although the method 950 is illustrated in FIG. 9B as having a particular flow of operations, in other implementations, more or fewer steps may exist. The steps of the method 950 may depend in part upon the end audience for the information. For example, rather than generating a report, the benchmark metrics may be supplied directly to a financial services organization for combining with the organization's internal data. The financial services organization engine 134 of FIG. 1, for example, may provide the risk metrics 154 to a financial services organization 110. Additionally, some steps of the method 950, in other embodiments may be performed in a different order than illustrated in FIG. 9B or in parallel. For example, the risk data may be retrieved once for the universe population and used to derive benchmark metrics for both the universe population and sub-populations (e.g., portfolio, peer group, etc.). In another example, the benchmark metrics for multiple strategies may be calculated in parallel (e.g., multiple threads of steps 954-960 executing simultaneously). Other modifications to the method 950 are possible while remaining with the scope and spirit of the disclosure.

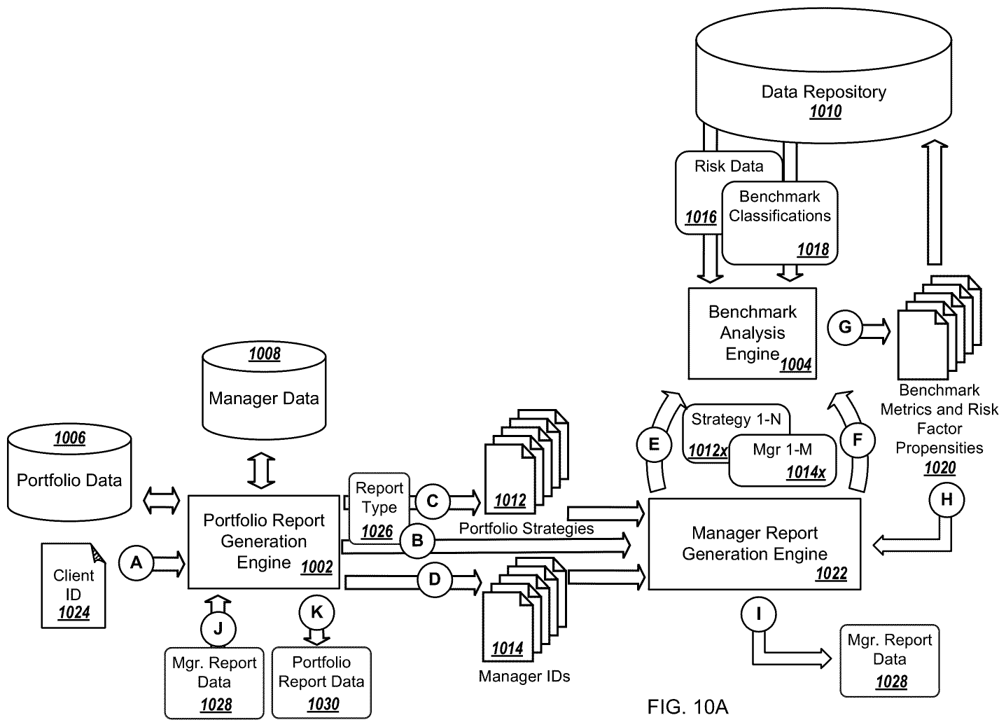

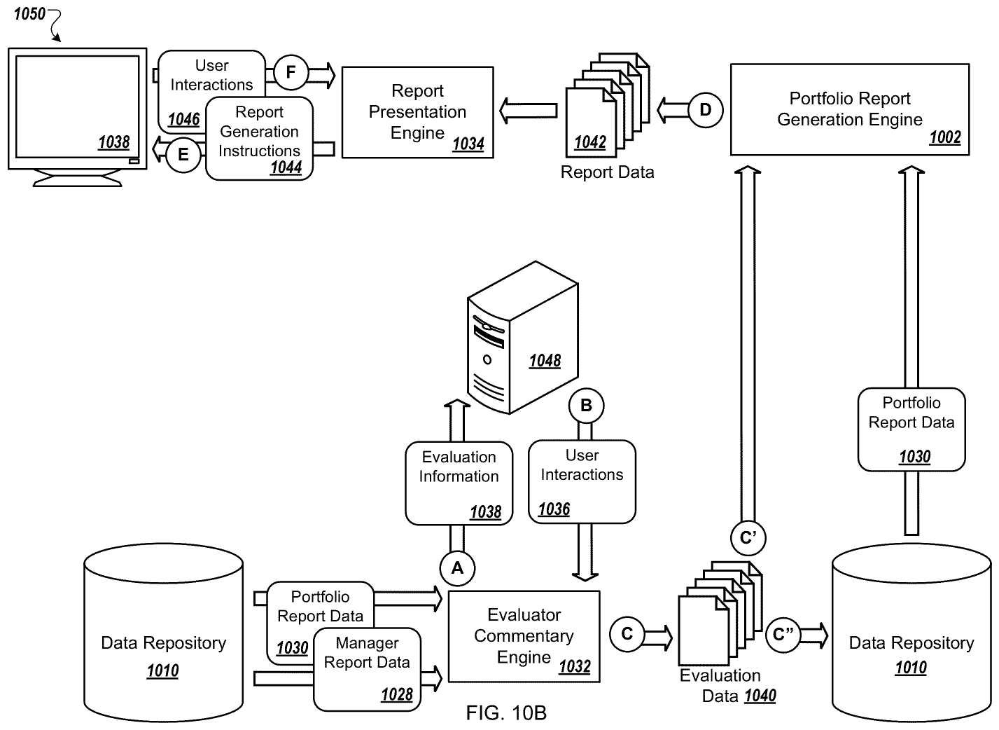

FIG. 10A is an operational flow diagram of an example process 1000 for automatically generating benchmark metrics for use in an ODD portfolio report. The process 1000, for example, may be performed by the operational assessment platform 102 to assess managers within a portfolio of one of the clients 104.

In some implementations, the process 1000 begins with a portfolio report generation engine 1002 receiving a client identifier 1024 that identifies a client having an investment vehicle portfolio. The client identifier 1024, in some examples, may identify a particular client 102 or portfolio of the portfolio data 138 of FIG. 1.

Responsive to receipt of the client identifier, in some implementations, the portfolio report generation engine 1002 retrieves portfolio data 1006 related to the client's portfolio, for example from a storage medium. In one example, the portfolio data may be portfolio data 138 retrieved by the portfolio report generation engine 132 of FIG. 1.

In some implementations, the portfolio report generation engine 1002 retrieves manager data 1008 related to one or more managers included in the client's investment vehicle portfolio, for example from a same or different storage medium. In illustration, the portfolio data 1006 for a set of portfolios and the manager data 1008 for a population of managers may be maintained in a database, and the client identifier 1024 may be used as a key to access portions of the database. The manager data 1008, for example, may be the manager data 142 of FIG. 1.

In some implementations, the portfolio generation engine 1002 extracts, from the manager data 1008 and the portfolio data 1006, a set of investment vehicle strategies 1012 included in the client's portfolio as well as a set of manager identifiers 1014 included in the client's portfolio. Each portfolio strategy 1012 may be provided by one or more of the managers 1014 such that managers 1014 and strategies 1012 are likely to have instances of one to many correlations.

In some implementations, the portfolio report generation engine 1002 provides an indication of report type(s) 1026 as well as the investment vehicle strategies 1012 and the manager identifiers 1014 to a manager report generation engine 1022. The report type(s), in some implementations, include both a firm management report and a strategy management report. In addition, portions of each of the firm management report and the strategy management report may be identified. For example, the client may wish to review the managers 1014 on the granularity of cybersecurity handling of the firm management risk categories. Further, the report type(s) may indicate an end audience (e.g., a client in the circumstance of a portfolio report). If the strategy management report is not selected within the report type(s), the portfolio strategies 1012 may still be useful in identifying appropriate peers to the various managers 1014. In other embodiments, if only a firm management report is desired, the portfolio report generation engine 1002 may not provide the portfolio strategies 1012.

The manager report generation engine 1022, in some implementations, automatically generates report data 1028, including risk factor metrics and population benchmark metrics 1020, related to each of the managers 1014 of the portfolio. The manager report generation engine 1022 may supply manager identifiers 1014a-x and strategy identifiers 1012a-x covering each of the N managers 1014 and M strategies 1012 provided by the portfolio report generation engine 1002 to a benchmark analysis engine 1004 for metrics generation.

In some implementations, the benchmark analysis engine 1004 obtains risk data 1016 regarding risk factors identified through analysis of survey data supplied by the managers 1014. The risk data 1016, for example, may be obtained from a data repository 1010 such as the data store 112 of FIG. 1. The risk data 1016, for example, may be the risk data 148 obtained by the survey analysis engine 122 as described in relation to FIG. 1.

In some implementations, the benchmark analysis engine 1004 also obtains benchmark classifications 1018, such as the benchmark classifications 154 of FIG. 1, that designate quantile classifications for apportioning metrics generated by the benchmark analysis engine 1004.

In some implementations, the benchmark analysis engine 1104 applies the benchmark classifications 1018 and the risk data 1016 to generating benchmark metrics and risk factor propensities 1020. The benchmark analysis engine 1004, for example, may perform the operations described in the method 900 of FIG. 9A and/or the operations describe in the method 950 of FIG. 9B to the generate benchmark metrics and risk factor propensities 1020 from the risk data 1016 and benchmark classifications 1018.

In some implementations, the benchmark analysis engine 1104 stores the benchmark metrics and risk factor propensities 1020 in the data repository 1010. The benchmark metrics and risk factor propensities, for example, may be generated by the benchmark analysis engine 124 of FIG. 1 and stored in the data repository 112 as risk metrics 154.

In some implementations, the benchmark analysis engine 1004 provides the benchmark metrics and risk factor propensities 1020 to the manager report generation engine 1022. Conversely, the manager report generation 1022 may access the benchmark metrics and risk factor propensities 1020 from the data repository 1010 (e.g., upon receiving a signal from the benchmark analysis engine that it has completed processing the portfolio strategies 1012 and manager identifiers 1014).

In some implementations, the manager report generation engine 1022 generates report data 1028 using the benchmark metrics and risk factor propensities 1020. The manager report generation engine 1022 may append the benchmark metrics and risk factor propensities 1020 with additional information, such as information regarding the managers 1014 (e.g., demographics, characteristics, etc.), information regarding the risk aspects, and/or information regarding the risk factors. The manager report generation engine 1022 may retrieve this information from the data repository 1010 and/or the manager data 1008 (which may be included in the data repository 1010 in some embodiments).

The manager report generation engine 1022, in some implementations, generates graphic content representing various benchmark metrics and risk factor propensities 1020. For example, turning to FIG. 2B, the manager report generation engine 1022 may create circle graphs 220, 222 representing risk factor propensities. In another example, turning to FIG. 4B, the manager report generation engine 1022 may create bar graphs such as the bar graph 422 representing risk propensities within the manager population.

In some implementations, the manager report generation engine 1022 combines the benchmark metrics and risk factor propensities 1020 with additional information, such as a title of the corresponding risk factor or a brief explanation of the best practice associated with the risk factor. For example, turning to FIG. 2B, the manager report generation engine 1022 may link risk propensities 220a, 222a derived from the manager population with exception details such as a risk factor identification 214a, a brief description of the risk factor 218a, and a best practice explanation 226a. Further, the management report generation engine 1022, in some embodiments, includes an investor sentiment information section or investor sentiment information tie-in (e.g., information overlay) regarding risk factors identified as being perceived as most important to investors. The investor sentiment data, for example, may be gathered through a separate survey process, manager feedback, and/or industry guidance as to most important areas of risk suppression.

The manager report generation engine 1022, in some implementations, analyzes the benchmark metrics and risk factor propensities 1020 to rank managers according to behaviors. For example, turning to FIG. 4B, a top 10 managers ranked by percentage of firm-related risk areas table 426 lists a subset of managers in a population of managers ranked by percentages of firm-level exceptions identified within the answers supplied by each of the managers.

In some implementations, the manager report generation engine 1022 provides the report data 1028 to the portfolio report generation engine 1002. In other embodiments, the manager report generation engine 1022 may store report data in the data repository 1010 or provide the report data 1028 to another engine for further processing. For example, turning to FIG. 10B, the manager report generation engine 1022 may provide the report data 1028 for use by an evaluator commentary engine 1032 to obtain manual review and additional commentary related to the automatically generated report data.

The portfolio report generation engine 1002, in some implementations, accesses the manager report data 1028 and generates portfolio report data 1030. The portfolio report generation engine 1002 may augment the manager report data 1028 with additional information, such as information regarding the client (e.g., demographics, characteristics, etc.) and/or the client's portfolio. The portfolio report generation engine 1002 may retrieve this information from the data repository 1010 or the portfolio data 1006 (which may be included in the data repository 1010 in some embodiments).

The portfolio report generation engine 1002, in some implementations, generates graphic content representing various benchmark metrics and risk factor propensities 1020. For example, turning to FIG. 3A, the portfolio report generation engine 1002 may create the circle graph 308 representing risk factor propensities across the managers of the portfolio. In another example, the portfolio report generation engine 1002 may create bar graphs such as the bar graph 310 representing firm related risk propensities in comparison to strategy related risk propensities within the manager population of the portfolio.

In some implementations, the portfolio report generation engine 1002 combines the benchmark metrics and risk factor propensities 1020 with additional information, such as a title of the corresponding risk factor or a brief explanation of the best practice associated with the risk factor. For example, turning to FIG. 4A, the portfolio report generation engine 1002 may link risk propensities 416 derived from the manager population with titles of risk aspects 412 and listings of risk factor identifications 414.

The portfolio report generation engine 1002, in some implementations, analyzes the benchmark metrics and risk factor propensities 1020 to rank risk factors, investment strategies, and/or manager-strategies. For example, as illustrated in FIG. 4A, a top 5 common firm level risks exceptions in highest quartile table 408 lists a subset of risk factors ranked by percentages of firm-level exceptions identified within the answers supplied by each of the managers. In another example, turning to FIG. 5B, strategies 528 are ranked by percentage of strategy-level risk exceptions 530 in the table 526.

Although described in relation to a particular sequence of operations (illustrated as A through I), in other implementations, more or fewer operations may be included, as well as more or fewer engines, data sources, and/or outputs. For example, in other embodiments, the portfolio report generation engine 1002 repeatedly issues requests to the manager report generation engine 1022, once for each manager 1014 or combination of manager-strategy (e.g., 1014 and 1012). In this manner, the portfolio report generation engine 1002 can obtain statistical information regarding each individual manager and/or manager-strategy. In other embodiments, the portfolio report generation engine 1002 may submit a single request to the manager report generation engine 1002 involving all managers 1014 and portfolio strategies 1012. The outcome of the request to the manager report generation engine 1022 may differ depending upon the scope of report generated by the manager report generation engine 1022. For example, if the benchmark metrics and risk factor propensities 1020 are only generated in view of a particular manager 1014 or manager-strategy 1014, 1012, additional benchmark metrics may need to be generated by the portfolio report generation engine 1002 (e.g., by directly issuing one or more requests to the benchmark analysis engine 1004).

Additionally, in other implementations, portions of the process 1000 may be performed in a different order or one or more of the steps may be performed in parallel. Other modifications to the process 1000 are possible while remaining in the scope and spirit of the disclosure.

FIG. 10B is an operational flow diagram of an example process 1030 for customizing report information with evaluator commentary and generating the ODD portfolio report for user review. The process 1030, for example, may be performed after the process 1000 of FIG. 10A has been executed to generate the benchmark metrics and risk factor propensities 1020 for the portfolio report

In some implementations, the process 1030 begins with the evaluator commentary engine 1032 receiving portfolio report data 1030 and/or manager report data 1028. The portfolio report generation engine 1002 and/or the manager report generation engine 1022, for example, may leave hooks in the respective generated report data 1030, 1028 for inclusion of customized comments added manually by an evaluator 1036. The evaluator commentary engine 1032, for example, may be the evaluator commentary engine 128 of FIG. 1.

In some implementations the evaluator commentary engine 1032 presents, in an interactive display, evaluation information, including portions of the portfolio report data 1030 and/or the manager report data 1028, to an evaluator at a computing device 1048. The evaluator may review report information provided by the evaluator commentary engine 1032 and submit manual additions to the automatically generated report for review by an end recipient of the report.

In response to presenting the evaluation information, in some implementations, the evaluator commentary engine receives user interactions 1036 from the evaluator at the computing device 1048. The user interactions 1036, for example, may include selections of some of the manager comments provided in the survey responses from the managers (e.g., the data entry fields provided along with standardized answers as discussed in relation to the survey presentation engine 120 of FIG. 1 and the process 800 of FIGS. 8A and 8B) for inclusion in the completed report. Further, the user interactions 1036 may include evaluator-entered comments providing context for portions of the information contained in the report data 1030, 1028. In some embodiments, the user interactions 1036 include overriding of a particular survey response and/or a risk aspect valuation associated with the survey response. For example, based upon manager comments, the evaluator may determine that the answer supplied by the manager does not appropriately match the level of risk described within the comments. The answer may be identified or flagged, in some embodiments, as having been adjusted by the evaluator.

The evaluator commentary engine, in some implementations, repeatedly supplies additional evaluation information 1038 and receives additional user interactions 1036 until the evaluator has completed evaluating all of the relevant portfolio report data 1030 and/or manager report data 1028. The evaluator, for example, may indicate an approval or final submission of entries capture in the user interactions 1036. Although described as a routine involving a single evaluator, in some embodiments, multiple evaluators may review portfolio report data 1030 and/or manager report data 1028 via the evaluator commentary engine 1032 and provide manually added information.

In some implementations, the evaluator commentary engine combines the finalized user interactions 1036 into evaluation data 1040 for incorporation into a finalized report. The evaluation data 1040 may be stored in a data repository 1010 (e.g., as evaluation data 156 of FIG. 1).

In some implementations, the portfolio report generation engine 1002 obtains the evaluation data 1040 and the portfolio report data 1030 and combines the information into finalized report data 1042. The portfolio report generation engine 1002, for example, may perform formatting of the evaluation data 1040 to seamlessly include it into the automated information in report data 1042 ready for presentation to an end recipient.

A report presentation engine 1034 such as the portal report presentation engine 118 of FIG. 1, in some implementations, provides report generation instructions 1044 for generating a report at a remote display device. The report generation instructions 1044, for example, may include web page presentation instructions or interactive screen instructions for an Internet portal accessed by a user of a computing device including or connected to the display 1038. The report generation instructions 1044, for example, may include instructions for presenting one or more of the example screen shots illustrated in FIGS. 2A-2D, 3A-3B, 4A-4B, 5A-5B, 6A-6C, and 7A-7B.

In some implementations, the recipient submits user interactions 1046, for example, to browse between screen shots and to drill deeper into report information provided by the report generation engine 1034.

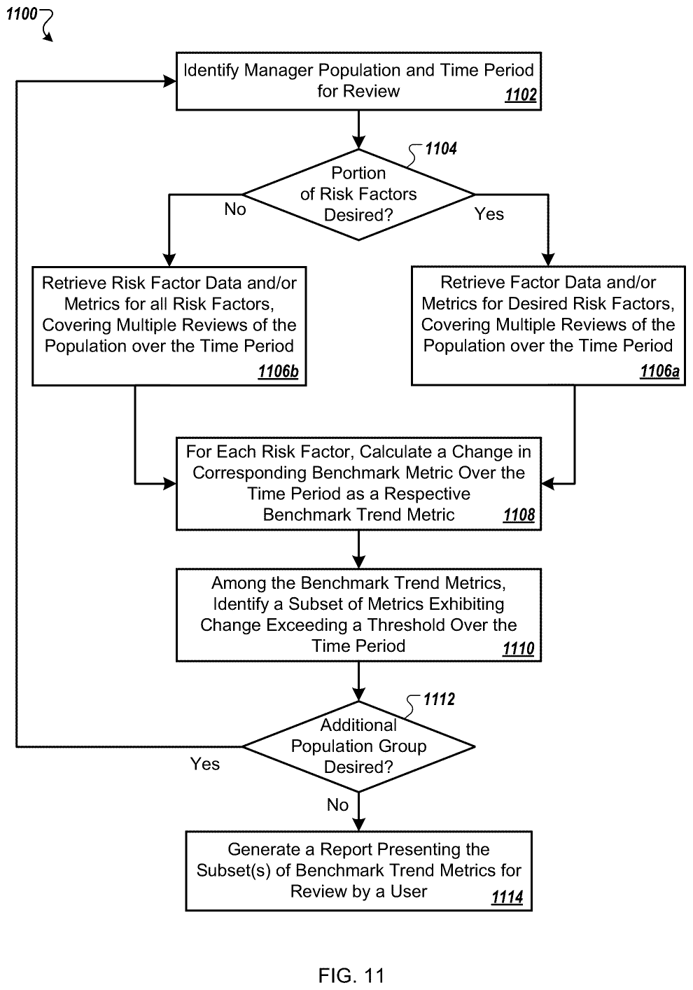

FIG. 11 is a flow chart of an example method 1100 for analyzing trends in automatically generated benchmark metrics associated with ODD assessments conducted over a period of time. The method 1100, for example, may be performed by the trend assessment engine 130 of FIG. 1.

In some implementations, the method begins with identifying a manager population and a time period for review (1102). The manager population, in some examples, may include the “universe” of managers, managers providing one or more particular strategies, or managers sharing certain characteristics (e.g., geography, size, maturity, etc.). In another example, a particular manager may be identified, for example to confirm that the manager demonstrates application of a greater number of best practices over time. The manager population may be submitted by a requesting user.

In some implementations, if a portion of risk factors are desired (1104), risk factor data and/or metrics are retrieved for the desired risk factors (1106a). For example, certain risk aspects of firm management may be identified, certain strategies, or certain strategy risk aspects. In other implementations, risk factor data and/or metrics for all risk factors, covering multiple reviews of the population over the time period, are retrieved (1106b). The benchmark metrics may cover multiple reviews of each manager within the population over the time period.

For each risk factor, in some implementations, a change in corresponding benchmark metric within the manager population over the time period is calculated as a respective benchmark trend metric (1108). The changes can include both increases and decreases in application of best practices. The trend metrics, for example, may be the trend metrics 150 of FIG. 1.

In some implementations, a subset of metrics exhibiting change exceeding a threshold over the time period is identified (1110). For example, adoption of certain best practices within a population of managers may be tracked through reviewing trends within multiple survey requests over time to identify clear demonstration in a trend toward (or away from) adoption of each best practice. The positively identify movement as a trend, the threshold may be set to, in some examples, at least 10%, over 20% or between 20 and 30%.

The method 1000 may be repeated (1112) for each population group of managers identified (1102). Once all population groups have been review, in some implementations, a report is generated presenting the subset(s) of benchmark trend metrics for review by a user (1114), such as the requester. The report may be in document form or in online interactive form, as discussed in relation to the portfolio and manager reports above.

Although the method 1100 is illustrated as having a particular flow of operations, in other implementations, more or fewer steps may exist. The steps of the method 1100 may depend in part upon the end audience for the information. For example, rather than generating a report, the trend metrics may be supplied directly to a financial services organization for combining with the organization's internal data. The financial services organization engine 134 of FIG. 1, for example, may provide the trend metrics 150 to a financial services organization 110. Additionally, some steps of the method 1100, in other embodiments may be performed in a different order than illustrated in FIG. 11 or in parallel. For example, the risk data may be retrieved once for the universe population and used to derive trend metrics for both the universe population and sub-populations (e.g., portfolio, peer group, etc.). In another example, the trend metrics for multiple strategies may be calculated in parallel (e.g., multiple threads of steps 1108 and 1110 executing simultaneously). Other modifications to the method 1100 are possible while remaining with the scope and spirit of the disclosure.

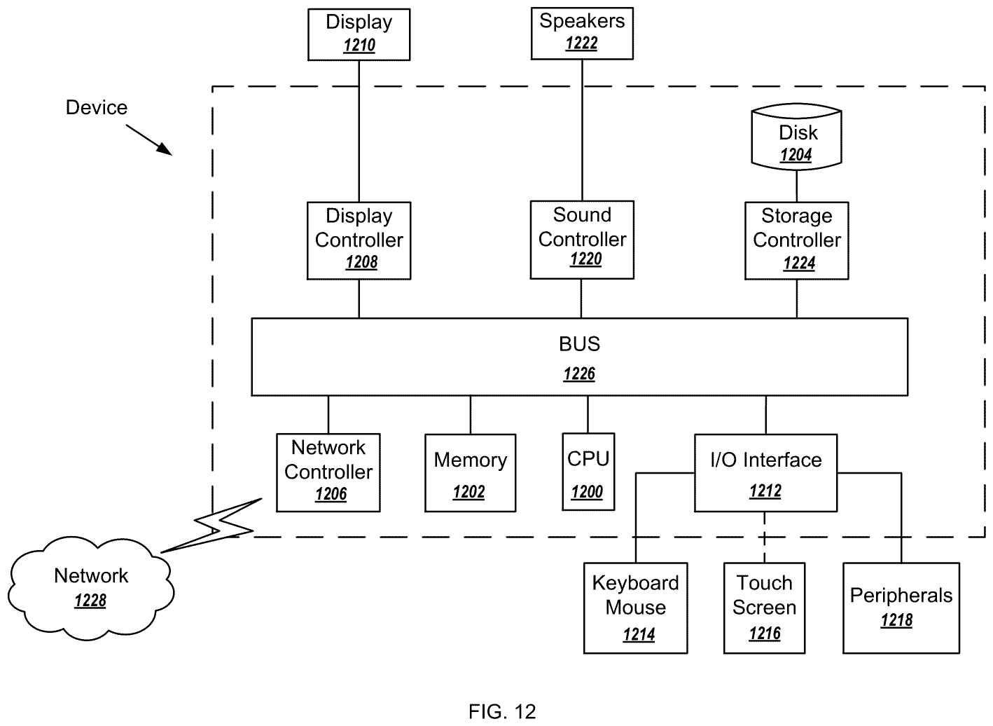

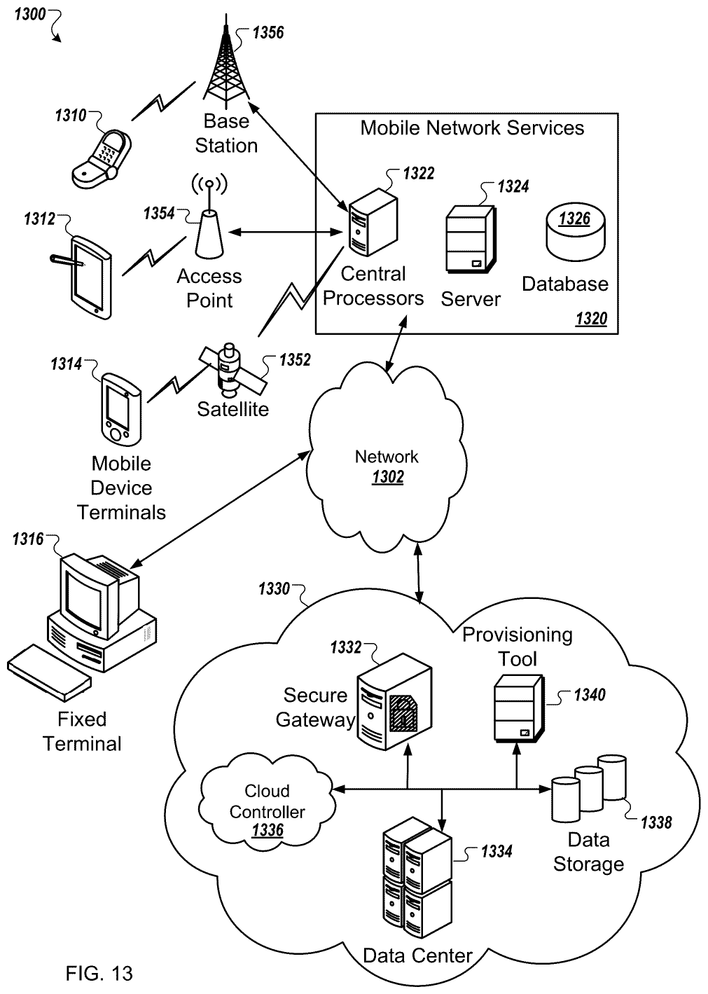

Next, a hardware description of the computing device, mobile computing device, or server according to exemplary embodiments is described with reference to FIG. 12. The computing device, for example, may represent the clients 104, financial services organizations 110, evaluators 108, regulators/auditors 114, managers 106, and/or one or more computing systems supporting the functionality of the operational assessment platform 102, as illustrated in FIG. 1, and/or the evaluator computing device 1048 of FIG. 10B. In FIG. 12, the computing device, mobile computing device, or server includes a CPU 1200 which performs the processes described above. The process data and instructions may be stored in memory 1202. The processing circuitry and stored instructions may enable the computing device to perform, in some examples, the methods described in relation to the various engines 116, 118, 120, 122, 124, 126, 128, 130, 132, 134, 136, and/or 137 of the operational assessment platform 102 of FIG. 1, including the process 800 of FIGS. 8A and 8B, the method 900 of FIG. 9A, the method 950 of FIG. 9B, the process 1000 of FIG. 10A, the process 1050 of FIG. 10B, or the method 1100 of FIG. 11. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The storage medium disk 1204, in some examples, may store the contents of the data repository 112 of FIG. 1, as well as, in some embodiments, certain data maintained by the clients 104, managers 106, regulators/auditors 114, and/or financial services organizations 110 prior to accessing the operational assessment platform 102 and transferring to the data repository 112. In other examples, the storage medium disk 1204, in some examples, may store the contents of the data store 806 of FIGS. 8A and 8B, and/or the portfolio data 1006, manager data 1008, and/or data repository 1010 of FIGS. 10A and 10B.

Further, a portion of the claimed advancements may be provided as a utility application, background daemon, or component of an operating system, or combination thereof, executing in conjunction with CPU 1200 and an operating system such as Microsoft Windows, UNIX, Solaris, LINUX, Apple MAC-OS and other systems known to those skilled in the art.

CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The computing device, mobile computing device, or server in FIG. 12 also includes a network controller 1206, such as an Intel Ethernet PRO network interface card from Intel Corporation of America, for interfacing with network 1228. As can be appreciated, the network 1228 can be a public network, such as the Internet, or a private network such as an LAN or WAN network, or any combination thereof and can also include PSTN or ISDN sub-networks. The network 1228 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known. The network 1228, for example, may support communications between the operational assessment platform and any one of the clients 104, evaluators 108, financial services organizations 110, regulators/auditors 114 or managers 106. Further, the network 1228 may support communications between the operational assessment platform 102 and the data repository 112, or between various engines 116, 118, 120, 122, 124, 126, 128, 130, 132, 134, 136, and/or 137 of the operational assessment platform 102 of FIG. 1, communications between the investment vehicle manager 802, the survey presentation engine 804, the survey analysis engine 808, and the data store 806 of FIGS. 8A and 8B, communications between the portfolio data 1006, the portfolio report generation engine 1002, the manager data 1008, the manager report generation engine 1022, the benchmark analysis engine 1004, and the data repository 1010 of FIG. 10A, and/or communications between the data repository 1010, evaluator commentary engine 1032, evaluator computing device 1048, portfolio report generation engine 1002, report presentation engine 1034, and remote computing device including display 1038 of FIG. 10B.

The computing device, mobile computing device, or server further includes a display controller 1208, such as a NVIDIA Geforce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard. The display controller 1208 and display 1210 may enable presentation of the user interfaces illustrated, in some examples, in FIGS. 2A-7B and/or the presentation of user interfaces at the display 1038 of FIG. 10B.

A sound controller 1220 is also provided in the computing device, mobile computing device, or server, such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device, mobile computing device, or server. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 9, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1330, such as Google Cloud Platform™ to perform at least portions of methods or algorithms detailed above. The processes associated with the methods described herein can be executed on a computation processor, such as the Google Compute Engine by data center 1334. The data center 1334, for example, can also include an application processor, such as the Google App Engine, that can be used as the interface with the systems described herein to receive data and output corresponding information. The cloud computing environment 1330 may also include one or more databases 1338 or other data storage, such as cloud storage and a query database. In some implementations, the cloud storage database 1338, such as the Google Cloud Storage, may store processed and unprocessed data supplied by systems described herein. For example, the portfolio data 138, population data 140, manager data 142, survey data 144, client data 146, risk data 148, trend metrics 150, rules data 152, risk metrics 154, evaluation data 156, benchmarks classifications 158, and/or evaluator data 160 of the operational assessment platform 102 of FIG. 1 may be stored in a database structure such as the databases 1338. In another example, the manager report data 1028, portfolio report data 1030, portfolio strategies 1012, manager identifiers 1014, benchmark classifications 1018, risk data 1016 and/or benchmark metrics and risk factor propensities 1020 of FIG. 10A may be stored in a database structure such as the databases 1338. Further, the evaluation information 1038, user interactions 1036, evaluation data 1040, report data 1042, report generation instructions 1044 and/or user interactions 1046 may be stored in a database structure such as the databases 1338.

The systems described herein may communicate with the cloud computing environment 1330 through a secure gateway 1332. In some implementations, the secure gateway 1332 includes a database querying interface, such as the Google BigQuery platform. The data querying interface, for example, may support access by the operational assessment platform to data stored on the data repository 112 or to data maintained by any one of the clients 104, evaluators 108, financial services organizations 110, regulators/auditors 114, or managers 106.

The cloud computing environment 1330 may include a provisioning tool 1340 for resource management. The provisioning tool 1340 may be connected to the computing devices of a data center 1334 to facilitate the provision of computing resources of the data center 1334. The provisioning tool 1340 may receive a request for a computing resource via the secure gateway 1332 or a cloud controller 1336. The provisioning tool 1340 may facilitate a connection to a particular computing device of the data center 1334.

A network 1302 represents one or more networks, such as the Internet, connecting the cloud environment 1330 to a number of client devices such as, in some examples, a cellular telephone 1310, a tablet computer 1312, a mobile computing device 1314, and a desktop computing device 1316. The network 1302 can also communicate via wireless networks using a variety of mobile network services 1320 such as Wi-Fi, Bluetooth, cellular networks including EDGE, 3G, 4G, and 5G wireless cellular systems, or any other wireless form of communication that is known. In some examples, the wireless network services 1320 may include central processors 1322, servers 1324, and databases 1326. In some embodiments, the network 1302 is agnostic to local interfaces and networks associated with the client devices to allow for integration of the local interfaces and networks configured to perform the processes described herein. Additionally, external devices such as the cellular telephone 1310, tablet computer 1312, and mobile computing device 1314 may communicate with the mobile network services 1320 via a base station 1356, access point 1354, and/or satellite 1352.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A method for applying automated analysis to operational due diligence reviews to objectively quantify risk factors across a population, the method comprising:
for each participant of a plurality of participants in a survey directed to performing an operational due diligence review, converting, by processing circuitry, survey contents into a plurality of risk data elements, the converting comprising
obtaining a plurality of standardized answers, wherein
each answer of the plurality of standardized answers corresponds to one of at least two potential answers for responding to a corresponding question of a plurality of questions of the survey, and
each answer of the plurality of standardized answers corresponds to a risk factor of a plurality of risk factors, each risk factor belonging to a given risk category of a plurality of risk categories,
accessing a plurality of analysis rules for analyzing the plurality of standardized answers to identify a subset of the plurality of standardized answers each corresponding to a failure to apply a best practice, wherein
each answer of the plurality of standardized answers corresponds a respective one rule of the plurality of analysis rules, and
applying the plurality of analysis rules to the plurality of standardized answers to generate the plurality of risk data elements, wherein
a number of the plurality of risk data elements is less than or equal to a number of the plurality of standardized answers, and
each risk data element of the plurality of risk data elements corresponds to a given risk factor of the plurality of risk factors;
for each risk factor of the plurality of risk factors, calculating, by the processing circuitry using one or more corresponding risk data elements of the plurality of risk data elements, a respective propensity across the plurality of participants for exhibiting an exception to the respective best practice,
using the propensity corresponding to each risk factor of the plurality of risk factors, calculating, by the processing circuitry, at least one metric representing group performance of the plurality of participants in meeting the respective best practice;
identifying, by the processing circuitry based on the group performance for each risk factor of the plurality of risk factors, one or more best practices a majority of the plurality of participants fail to follow; and
generating, by the processing circuitry for review by a user, a report comprising identification of the one or more best practices the majority of the plurality of the participants fail to follow.
